(19) United States
(12) Patent Application Publication
(10) Pub. No.: US 2024/0061475 A1
(43) Pub. Date: Feb. 22, 2024

(54) WINDOW AND DISPLAY DEVICE INCLUDING THE SAME

(71) Applicants: Samsung Display Co., LTD., Yongin-si (KR); SK Innovation Co., Ltd., Seoul (KR); SK ie technology Co. , Ltd., Seoul (KR)

(72) Inventors: NAMHEE PARK, Yongin-si (KR); JEONGMIN CHOI, Seoul (KR); SEONGWOOK KANG, Seoul (KR); KEONHYEOK KO, Seoul (KR); MINSANG PARK, Seoul (KR); HANSOL KANG, Yongin-si, Gyeonggi-do (KR); SANG-IL PARK, Yongin-si (KR); YOUNGSANG PARK, Yongin-si (KR); INSEOK SEO, Yongin-si (KR); SUNGGUK AN, Yongin-si (KR)

(21) Appl. No.: 18/231,452

(22) Filed: Aug. 8, 2023

(30) Foreign Application Priority Data
Aug. 12, 2022 (KR) 10-2022-0101260

(51) Int. Cl. G06F 1/16; H04M 1/02; G02B 1/14

(52) U.S. Cl. CPC G06F 1/1656; G06F 1/1652; G06F 1/1616; H04M 1/0216; H04M 1/0268; G02B 1/14

(57) ABSTRACT

A window includes at least one protective film member including a base film, a lower antistatic layer disposed below the base film, an optical layer disposed between the base film and the lower antistatic layer and having a lower refractive index than a refractive index of the base film, an upper antistatic layer disposed above the base film, an anti-fingerprint layer disposed above the base film, and a hard coating layer disposed between the base film and the anti-fingerprint layer and consisting of a siloxane-epoxy-based compound, thereby exhibiting both excellent mechanical properties and excellent optical properties.

This application claims priority to Korean Patent Application No. 10-2022-0101260, filed on Aug. 12, 2022, and all the benefits accruing therefrom under 35 U.S.C. § 119, the content of which in its entirety is herein incorporated by reference.

### BACKGROUND

### 1. Field

The disclosure herein relates to a window and a display device including the window, and more particularly, to a window including a film substrate and a flexible display device including the window.

### 2. Description of the Related Art

Various types of display devices are being used to provide image information, and electronic devices including flexible display devices that are foldable or bendable are being developed lately. The flexible display devices, unlike rigid display devices, are variously modifiable in shape by being foldable, rollable, or bendable, and thus have portability without being limited to display screen sizes.

Such a flexible display device is desired to include a window to protect a display panel without hurting folding or bending operation, and accordingly, it is desired to develop a window having satisfactory folding characteristics and excellent mechanical properties.

### SUMMARY

The disclosure provides a window having excellent abrasion resistance, chemical resistance, or the like, and having excellent optical quality as well.

The disclosure also provides a display device including a window having excellent durability and optical properties.

An embodiment of the inventive concept provides a window including a protective film member including a base film, a lower antistatic layer disposed below the base film, an optical layer disposed between the base film and the lower antistatic layer and having a lower refractive index than a refractive index of the base film, an upper antistatic layer disposed above the base film, an anti-fingerprint layer disposed above the base film, and a hard coating layer disposed between the base film and the anti-fingerprint layer and consisting of a siloxane-epoxy-based compound.

In an embodiment, the hard coating layer may be directly disposed on the base film, the upper antistatic layer may be directly disposed on the hard coating layer, and the anti-fingerprint layer may be directly disposed on the upper antistatic layer.

In an embodiment, the upper antistatic layer may be directly disposed on the base film, the hard coating layer may be directly disposed on the upper antistatic layer, and the anti-fingerprint layer may be directly disposed on the hard coating layer.

In an embodiment, the window may further include a glass substrate disposed below the lower antistatic layer of the protective film member.

In an embodiment, the window may include a glass substrate, a module protective layer disposed on the glass substrate, and a cover protective layer disposed on the module protective layer, and at least one of the module protective layer or the cover protective layer may be the protective film member.

In an embodiment, the module protective layer may be the protective film member, the cover protective layer may include a base layer including a polymer film and an upper functional layer disposed on the base layer, and the upper functional layer may include an acrylic hard coating agent.

In an embodiment, the cover protective layer may be the protective film member, the module protective layer may include a base layer including a polymer film and an upper functional layer disposed on the base layer, and the upper functional layer may include an acrylic hard coating agent.

In an embodiment, the window may further include a shock absorbing layer disposed below the protective film member. The shock absorbing layer may include a polyethylene terephthalate film.

In an embodiment, the window may further include a glass substrate disposed between the protective film member and the shock absorbing layer.

In an embodiment, the base film may be a polyimide film or a polyethylene terephthalate film.

In an embodiment, the base film may have a thickness of about 10 micrometer (μm) to about 150 μm.

In an embodiment, the hard coating layer may be formed from a hard coating composition consisting of an alkoxysilane condensate having an epoxy group.

In an embodiment, the hard coating may further include a crosslinking agent having a multifunctional epoxy group.

In an embodiment, the alkoxysilane condensate having the epoxy group may be a silsesquioxane resin having the epoxy group.

In an embodiment, the hard coating layer may have a thickness of about 1 μm to about 100 μm.

In an embodiment, the lower antistatic layer and the upper antistatic layer may include of an antistatic composition including any one conductive agent selected from carbon nanotubes, carbon nanofibers, and conductive polymers, and an epoxy-based resin binder.

In an embodiment, the lower antistatic layer and the upper antistatic layer may each have a surface resistance of less than about 10¹⁰ ohm per square (Ω/□).

In an embodiment, the anti-fingerprint layer may be formed from an anti-fingerprint composition including an alkoxysilane compound consisting of a polyalkylene glycol group and a perfluorinated substituent.

In an embodiment, an initial water contact angle of an exposed surface of the anti-fingerprint layer may be about 110° or greater.

In an embodiment, a water contact angle of the exposed surface of the anti-fingerprint layer may be about 95° or greater after an anti-scratch test, and a water contact angle of the exposed surface of the anti-fingerprint layer may be about 95° or greater after abrasion resistance and chemical resistance tests.

In an embodiment, the anti-fingerprint layer may have a thickness of about 1 nanometer (nm) to about 100 nm.

In an embodiment, the optical layer may include hollow silica. The hollow silica may have an average diameter of about 50 nm to about 150 nm.

In an embodiment, the protective film member may have a reflectance of 7% or less.

In an embodiment, the window may include at least one folding portion folded with respect to a folding axis extending in one direction.

In an embodiment of the inventive concept, a display device includes a folding region, and a first non-folding region and a second non-folding region spaced apart with the folding region therebetween, and includes: a display module, and a window disposed on the display module. The window includes at least one protective film member including a base film, a lower antistatic layer disposed below the base film, an optical layer disposed between the base film and the lower antistatic layer and having a lower refractive index than a refractive index of the base film, an upper antistatic layer disposed above the base film, an anti-fingerprint layer disposed above the base film, and a hard coating layer disposed between the base film and the anti-fingerprint layer and consisting of a siloxane-epoxy-based compound.

In an embodiment, when the first non-folding region and the second non-folding region are folded to overlap each other,

a distance between upper surfaces of the overlapping display module may be smaller than a distance between the upper surfaces of the overlapping window.

In an embodiment, when the first non-folding region and the second non-folding region are folded to overlap each other, the anti-fingerprint layer may be exposed to an outermost surface.

In an embodiment, the window may include a glass substrate, a module protective layer disposed on the glass substrate, and a cover protective layer disposed on the module protective layer, and at least one of the module protective layer or the cover protective layer may be the protective film member.

In an embodiment, the base film may be a polyimide film or a polyethylene terephthalate film.

In an embodiment, the hard coating layer may be formed from a hard coating composition consisting of an alkoxysilane condensate having an epoxy group.

In an embodiment, the lower antistatic layer and the upper antistatic layer may consist of an antistatic composition including any one conductive agent selected from carbon nanotubes, carbon nanofibers, and conductive polymers, and an epoxy-based resin binder.

In an embodiment, the anti-fingerprint layer may be formed from an anti-fingerprint composition including an alkoxysilane compound consisting of a polyalkylene glycol group and a perfluorinated substituent.

In an embodiment, an initial water contact angle of an exposed surface of the anti-fingerprint layer may be about 110° or greater.

In an embodiment, the optical layer may include hollow silica. The hollow silica may have an average diameter of about 50 nm to about 150 nm.

In an embodiment, the window may have a reflectance of about 7% or less.

### BRIEF DESCRIPTION OF THE DRAWINGS

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1A is a perspective view showing an embodiment of a state in which a display device is unfolded;

FIG. 1B is a perspective view showing an embodiment of an in-folding process of the display device shown in FIG. 1A;

FIG. 1C is a perspective view showing an embodiment of an out-folding process of the display device shown in FIG. 1A;

FIG. 2 is a cross-sectional view showing an embodiment of a state in which a display device is folded;

FIG. 3 is an exploded perspective view of an embodiment of a display device;

FIG. 4 is a cross-sectional view of an embodiment of a display device;

FIG. 5 is a cross-sectional view of an embodiment of a window;

FIG. 6 is a cross-sectional view of an embodiment of a window.

FIG. 7A is a cross-sectional view of an embodiment of a window;

FIG. 7B is a cross-sectional view of an embodiment of a window;

FIG. 7C is a cross-sectional view of an embodiment of a window;

FIG. 7D is a cross-sectional view of an embodiment of a window;

FIG. 8 is a cross-sectional view of an embodiment of a window; and

FIG. 9 is a cross-sectional view of an embodiment of a window.

### DETAILED DESCRIPTION

The disclosure may be modified in many alternate forms, and thus illustrative embodiments will be exemplified in the drawings and described in detail. It should be understood, however, that it is not intended to limit the disclosure to the particular forms disclosed, but rather, is intended to cover all modifications, equivalents, and alternatives falling within the spirit and scope of the disclosure.

In the description, when an element (or a region, a layer, a portion, etc.) is referred to as being “on,” “connected to,” or “coupled to” another element, it means that the element may be directly disposed on/connected to/coupled to the other element, or that a third element may be disposed therebetween.

In the description, “directly disposed” may indicate that there is no layer, film, region, plate or the like added between a portion of a layer, a film, a region, a plate or the like and other portions. For example, “directly disposed” may indicate disposing without additional members such as an adhesive member between two layers or two members. Like reference numerals refer to like elements.

In addition, in the drawings, the thickness, the ratio, and the dimensions of elements are exaggerated for an effective description of technical contents. The term “and/or,” includes all combinations of one or more of which associated configurations may define.

It will be understood that, although the terms “first”, “second”, and the like may be used herein to describe various elements, these elements should not be limited by these terms. These terms are only used to distinguish one element from another. For example, a first element could be termed a second element, and, similarly, a second element could be termed a first element, without departing from the scope of example embodiments of the inventive concept. The terms of a singular form may include plural forms unless the context clearly indicates otherwise.

Also, terms of “below”, “on lower side”, “above”, “on upper side”, or the like may be used to describe the relationships of the components illustrated in the drawings. The terms are used as a relative concept and are described with reference to the direction indicated in the drawings. In the specification, being “disposed on” may represent not only being disposed on the top surface but also being disposed on the bottom surface.

It should be understood that the terms “comprise”, or “have” are intended to specify the presence of stated features, integers, steps, operations, elements, components, or combinations thereof in the disclosure, but do not preclude the presence or addition of one or more other features, integers, steps, operations, elements, components, or combinations thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term “about” can mean within one or more standard deviations, or within ±30%, 20%, 10%, 5% of the stated value, for example.

Unless otherwise defined, all terms (including technical and scientific terms) used herein have the same meaning as commonly understood by one of ordinary skill in the art to which the inventive concept pertains. It is also to be understood that terms defined in commonly used dictionaries should be interpreted as having meanings consistent with the meanings in the context of the related art, and are expressly defined herein unless they are interpreted in an ideal or overly formal sense.

Hereinafter, a window in an embodiment of the inventive concept and a display device including the window will be described with reference to the accompanying drawings.

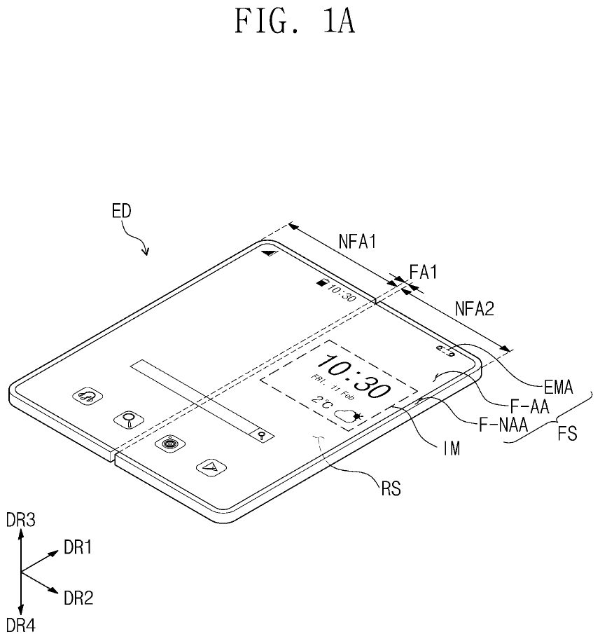

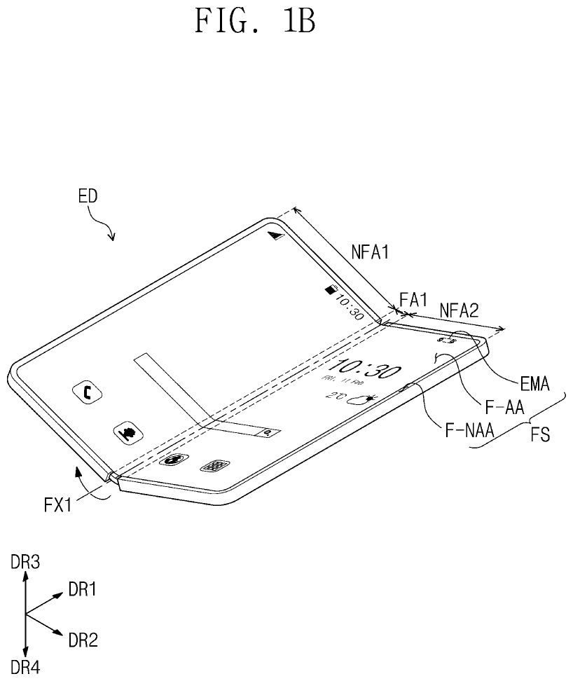

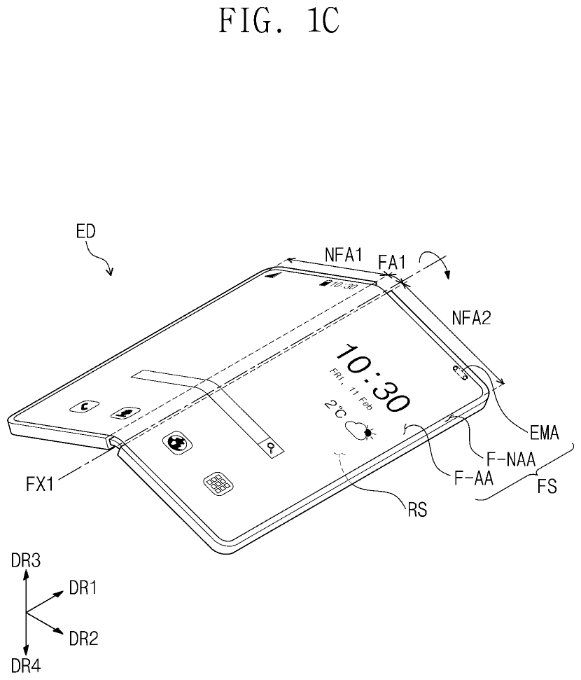

FIG. 1A is a perspective view showing an embodiment of a state in which a display device is unfolded. FIG. 1B is a perspective view showing an in-folding process of the display device shown in FIG. 1A. FIG. 1C is a perspective view showing an out-folding process of the display device shown in FIG. 1A.

A display device ED may be a device activated according to electrical signals. In an embodiment, the display device ED may be a mobile phone, a tablet, a car navigation system, a game console, or a wearable device, for example, but the inventive concept is not limited thereto. In FIG. 1A, or the like of the description, in an embodiment, the display device ED is shown as a mobile phone.

FIG. 1A and the following drawings show the first to fourth directional axes DR1 to DR4, and directions indicated by the first to fourth directional axes DR1 DR2, DR3, and DR4 as described herein are relative concepts, and may thus be changed to other directions. In addition, the directions indicated by the first to fourth directional axes DR1 DR2, DR3, and DR4 may be described as first to fourth directions, and the same reference numerals may be used.

Referring to FIGS. 1A to 1C, the display device ED in an embodiment may include a first display surface FS defined by a first directional axis DR1 and a second directional axis DR2 crossing the first directional axis DR1. The display device ED may provide an image IM to users through the first display surface FS. The display device ED in an embodiment may display an image IM towards the third directional axis DR3 on the first display surface FS parallel to a first directional axis DR1 and a second directional axis DR2, respectively. In the description, a front surface (or an upper surface) and a rear surface (or a lower surface) of respective members are defined with respect to a direction in which the image IM is displayed. In the description, the image IM is displayed in the direction of the third directional axis DR3, and the direction of the fourth directional axis DR4 may be defined as a direction opposing the direction of the third directional axis DR3.

The display device ED in an embodiment may include the first display surface FS and a second display surface RS. The first display surface FS may include a first active area F-AA and a first peripheral area F-NAA. The first active area F-AA may include an electronic module area EMA. The second display surface RS may be defined as a surface facing at least a portion of the first display surface FS. That is, the second display surface RS may be defined as a portion of the rear surface of the display device ED.

The display device ED in an embodiment may detect external inputs applied from the outside. The external inputs may include various forms of inputs provided from outside the display device ED. In an embodiment, the external inputs may include external inputs applied when approaching the display device ED or being adjacent by a predetermined distance (e.g., hovering), as well as contact by body parts such as a user's hand, for example. In addition, the external inputs may have various forms such as force, pressure, temperature, and light.

The display device ED may include a folding region FA1 and non-folding regions NFA1 and NFA2. The display device ED in an embodiment may include a first non-folding region NFA1 and a second non-folding region NFA2 disposed with the folding region FAT therebetween. FIGS. 1A to 1C shows an embodiment of the display device ED including one folding region FA1, but the inventive concept is not limited thereto, and in the display device ED, a plurality of folding regions may be defined.

Referring to FIG. 1B, the display device ED in an embodiment may be folded with respect to the first folding axis FX1. The first folding axis FX1 is a virtual axis extending in a direction of the first directional axis DR1, and the first folding axis FX1 may be parallel to a long side direction of the display device ED. The first folding axis FX1 may extend along the first directional axis DR1 on the first display surface FS.

In an embodiment, the non-folding regions NFA1 and NFA2 may be disposed adjacent to the folding region FA1 with the folding region FA1 therebetween. In an embodiment, the first non-folding region NFA1 may be disposed at one side of the folding region FA1 in the second direction axis DR2, and the second non-folding region NFA2 may be disposed at the other side of the folding region FA1 in the second direction axis DR2, for example.

The display device ED may be folded with respect to the first folding axis FX1 to become in-folded such that one area overlapping the first non-folding region NFA1 and the other area overlapping the second non-folding region NFA2 on the first display surface FS face each other. In the display device ED in an embodiment, the second display surface RS may be viewed in an in-folded state by users. The second display surface RS may further include an electronic module area in which an electronic module including various components is disposed, and is not limited to any particular embodiment.

Referring to FIG. 1C, the display device ED may be folded with respect to the first folding axis FX1 to become out-folded such that one area overlapping the first non-folding region NFA1 and the other area overlapping the second non-folding region NFA2 on the second display surface RS face each other. However, the inventive concept is not limited thereto, and the display device ED may be folded with respect to a plurality of folding axes such that portions of each of the first display surface FS and the second display surface RS may face each other, and the number of folding axes and the number of the corresponding non-folding regions are not particularly limited. When the display device ED in an embodiment is deformed to be out-folded, the first display surface FS may be exposed to the outside.

Various electronic modules may be disposed in an electronic module area EMA of the display device ED. In an embodiment, the electronic module may include at least any one among a camera, a speaker, a light detection sensor, and a heat detection sensor. The electronic module area EMA may detect an external subject received through the first and second display surfaces FS and RS, or provide sound signals such as voice to the outside through the first and second display surfaces FS and RS. The electronic modules may include a plurality of components, and are not limited to any particular embodiment.

FIGS. 1A to 1C show an embodiment in which a direction that the first folding axis FX1 extends is parallel to a long side of a display device, but the inventive concept is not limited thereto, and in an embodiment, the folding region FA1 may be folded with respect to a folding axis parallel to a short side of a display device.

The display device ED of an embodiment described with reference to FIGS. 1A to 1C may be configured such that an in-folding operation or an out-folding operation is alternately repeated from an unfolding operation, but the inventive concept is not limited thereto. In an embodiment, the display device ED may select any one among an unfolding operation, an in-folding operation, and an out-folding operation. In in an embodiment, the display device ED may be configured by selecting an unfolding operation and an out-folding operation, and in the display device ED in which the out-folding operation is selected, the first display surface FS may be directly exposed to users, for example.

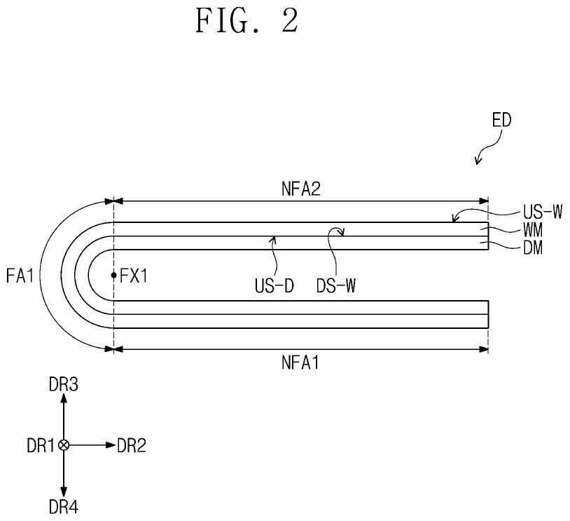

FIG. 2 is a side view showing an embodiment of a state in which a display device is folded. In the side view of FIG. 2, a folded state of the display device ED is schematically shown only with components such as a display module DM and a window WM. When the display device ED in an embodiment is folded, the first non-folding region NFA1 and the second non-folding region NFA2 may overlap. When the first non-folding region NFA1 and the second non-folding region NFA2 overlap, a distance between upper surfaces US-D of the overlapping display modules DM in the display device ED in an embodiment may be smaller than a distance between upper surfaces US-W of the overlapping window WM. That is, the display device ED of an embodiment may be an out-folding display device in which the window WM is exposed to an outermost surface in a folded state. The window WM in an embodiment has excellent mechanical properties and durability, and may thus protect the display module DM from external shocks even when the first display surface FS (FIG. TA) is folded to be exposed to the outside. In an embodiment, a lower surface DS-W of the window WM may contact the upper surface US-D of the overlapping display modules DM.

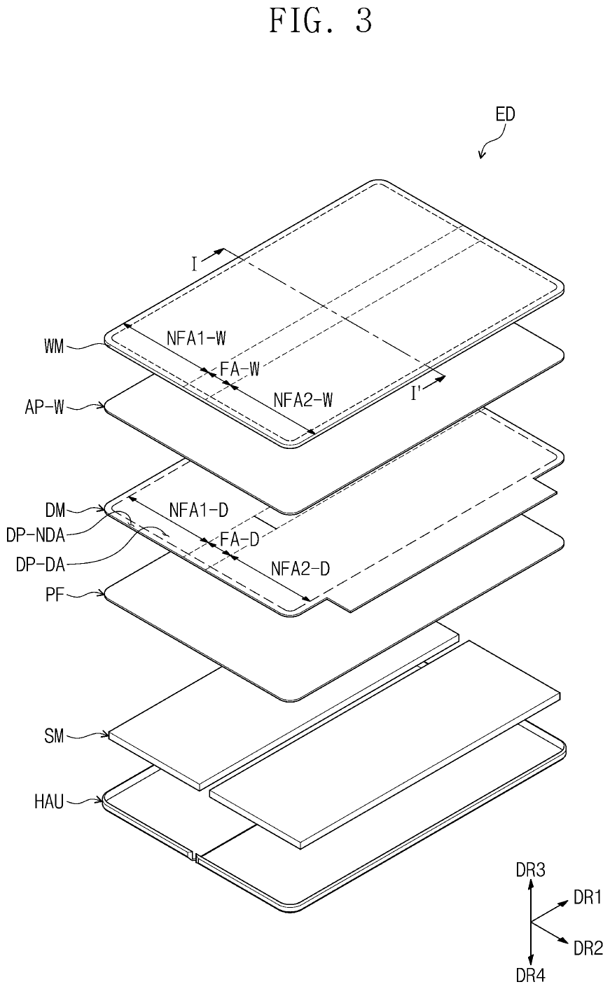

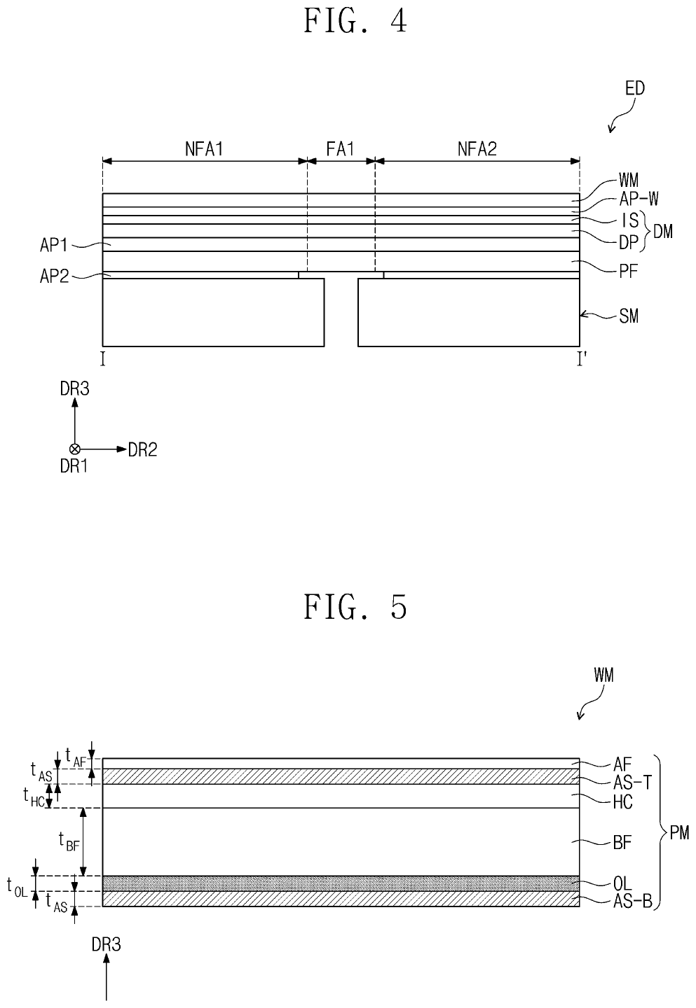

FIG. 3 is an exploded perspective view of an embodiment of a display device. FIG. 4 is a cross-sectional view of an embodiment of a display device. FIG. 4 is a cross-sectional view corresponding to line I-I′ of FIG. 3.

Referring to FIGS. 3 and 4, the display device ED of an embodiment may include a display module DM and a window WM disposed on the display module DM. The display device ED of an embodiment may include a window adhesive layer AP-W disposed between the display module DM and the window WM, a lower module SM disposed below the display module DM, and a support layer PF.

The window WM may cover the entirety of the upper surface of the display module DM. The window WM may have a shape corresponding to the shape of the display module DM. The window WM may have flexibility that is deformed according to the folding or bending operation of the display device ED. In addition, the window WM may serve to protect the display module DM from external impacts. The window WM in an embodiment will be described in more detail later.

The display module DM may include a display panel DP, and an input sensor IS disposed on the display panel DP. The display panel DP may include a display element layer. In an embodiment, the display element layer may include an organic electroluminescence element, a quantum dot light-emitting element, or a liquid crystal element layer, for example. However, the inventive concept is not limited thereto.

The input sensor IS may include a plurality of sensing electrodes for detecting external inputs. The input sensor IS may be directly formed on the display panel DP through a continuous process when the display panel DP is manufactured. However, the inventive concept is not limited thereto, and the input sensor IS may be manufactured as a separate panel from the display panel DP, and be attached to the display panel DP through an adhesive layer (not shown).

The display device ED of an embodiment may include a housing HAU accommodating the display module DM, the lower module SM, or the like. The housing HAU may be bonded to the window WM. Although not shown, the housing HAU may further include a hinge structure to make folding or bending easy.

In the display device ED of an embodiment, the window adhesive layer AP-W disposed between the window WM and the display module DM may be an optically clear adhesive film (“OCA”) or an optically clear adhesive resin layer (“OCR”). In an embodiment, the window adhesive layer AP-W may be omitted.

The display module DM may display images according to electrical signals and transmit/receive information on external inputs. The display module DM may include a display area DP-DA and a non-display area DP-NDA. The display region DP-DA may be defined as a region outputting images provided from the display module DM.

In the display device ED in an embodiment, the display module DM may include a folding display portion FA-D and non-folding display portions NFA1-D and NFA2-D. The folding display portion FA-D may be a portion corresponding to the folding region FA1 (FIG. 1A), and the non-folding display portions NFA1-D and NFA2-D may be portions corresponding to the non-folding regions NFA1 and NFA2 (FIG. 1A).

Also, the window WM may include a folding portion FA-W and non-folding portions NFA1-W and NFA2-W. The folding portion FA-W may be a portion corresponding to the folding region FA1 (FIG. 1A), and the non-folding portions NFA1-W and NFA2-W may be portions corresponding to the non-folding regions NFA1 and NFA2 (FIG. 1A).

In the display device ED in an embodiment, the lower module SM may include at least one of a support plate, a cushion layer, a shielding layer, a filling layer, or an inter-bonding layer. The lower module SM may support the display module DM or may prevent the display module DM from being deformed due to an external impact or force.

The support plate may include or consist of a metal material or a polymer material. The cushion layer may include sponge, foam, or elastomer such as a urethane resin. The shielding layer may be an electromagnetic wave shielding layer or a heat dissipation layer. In addition, the shielding layer may serve as an adhesive layer. The inter-bonding layer may be provided in the form of an adhesive resin layer or an adhesive tape. The filling layer may fill a space between the support layer PF and the housing HAU, and fix the support layer PF.

The support layer PF may be a layer disposed below the display module DM to protect a rear surface of the display module DM. The support layer PF may overlap the entirety of the display module DM. The support layer PF may include a plastic material. In an embodiment, the support layer PF may be a polyimide (“PI”) film or a polyethylene terephthalate (“PET”) film, for example. However, this is presented in an embodiment, and the material of the support layer PF is not limited thereto.

In addition, the display device ED of an embodiment may further include at least one adhesive layer AP1 or AP2. In an embodiment, the first adhesive layer AP1 may be disposed between the display module DM and the support layer PF and the second adhesive layer AP2 may be disposed between the support layer PF and the lower module SM, for example. The at least one adhesive layer AP1 or AP2 may be an optically clear adhesive film (“OCA”) or an optically clear adhesive resin layer (“OCR”).

The display device ED in an embodiment described with reference to FIGS. 1A to 4 may include a display module DM and a window WM disposed on the display module DM, and may include at least one folding region.

The structure of the display device in an embodiment is not limited to what is shown, and the display device may be provided as one including a plurality of folding regions, or as one in which a direction that a folding axis extends, which is a reference for folding, is not limited to what is shown, but the folding axis extends in various directions. In addition, the display device in an embodiment may be a flexible display device in which at least some portions thereof are bendable or rollable.

The display device in an embodiment includes a window of an embodiment which will be described later to effectively protect a display module through excellent mechanical properties of the window even when the window is out-folded and exposed to the outside, may thus exhibit excellent reliability. In addition, the display device in an embodiment includes a window of an embodiment having reduced reflectance, and the display device may thus have reduced reflectance to exhibit excellent display quality.

Hereinafter, a window of an embodiment will be described with reference to FIGS. 5 to 9, or the like. The window in an embodiment described with reference to FIGS. 5 to 9 may be included as a window WM of the display device ED in an embodiment described with reference to FIGS. 1A to 4. The window in an embodiment described with reference to FIGS. 5 to 9 may be used as a cover window of the display device ED.

The window in an embodiment described with reference to FIGS. 5 to 9 may include at least one folding portion FA-W (FIG. 3) which is folded with respect to the first folding axis FX1 (FIG. 2) extending in one direction.

Referring to FIG. 5, the window WM of an embodiment may include a protective film member PM including a base film BF, a hard coating layer HC, antistatic layers AS-T and AS-B, an optical layer OL, and an anti-fingerprint layer AF.

The window WM in an embodiment may include at least one protective film member PM. Although FIG. 5 shows a window WM including one protective film member PM, the window WM of an embodiment may include two protective film members PM stacked in the third directional axis DR3 (thickness direction). In this case, each of the protective film members PM may include a base film BF, a hard coating layer HC, antistatic layers AS-T and AS-B, an optical layer OL, and an anti-fingerprint layer AF. However, the base film BF, the hard coating layer HC, the antistatic layers AS-T and AS-B, the optical layer OL, and the anti-fingerprint layer AF of the two protective film members PM may have different thicknesses and component materials. However, the inventive concept is not limited thereto, and protective film members PM having the same structure may be stacked in the thickness direction and provided.

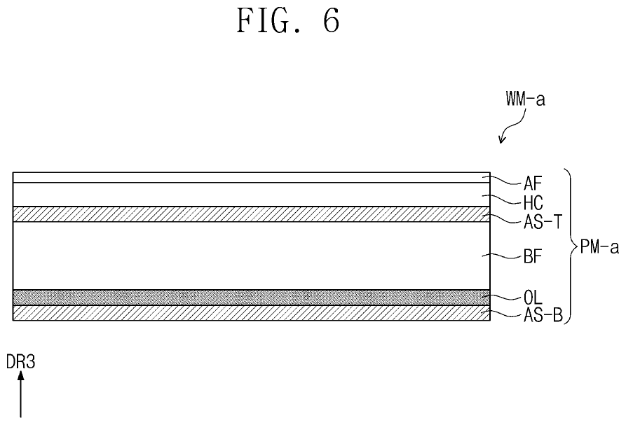

Hereinafter, descriptions of the base film BF, the hard coating layer HC, the antistatic layers AS-T and AS-B, the optical layer OL, and the anti-fingerprint layer AF included in the protective film member PM may also be applied to components of the window WM of an embodiment shown in FIG. 5 as well as the window of an embodiment described with reference to FIGS. 6 to 9.

The base film BF in an embodiment may include or consist of a polymer material. The base film BF may be a flexible polymer film. In an embodiment, the base film BF may have substantially high transparency, substantially high mechanical strength, substantially high thermal stability, excellent moisture barrier properties, and optical isotropy.

The base film BF may include or consist of polyimide-based resins; polyaramid-based resins; polyester resins such as polyethylene terephthalate, polyethylene isophthalate, or polybutylene terephthalate; cellulosic resins such as diacetyl cellulose or triacetyl cellulose; polycarbonate-based resins; acrylic resins such as polymethyl (meth)acrylate or polyethyl (meth)acrylate; styrenic resins such as a polystyrene acrylonitrile-styrene copolymer; polyolefin-based resins such as polyethylene, polypropylene, a polyolefin-based resin having a cyclo-based or norbornene structure, and an ethylene-propylene copolymer; a polyethersulfone-based resins; sulfone-based resins, or the like. In addition, the base film BF may include or consist of one of the above resins alone or a combination of two or more resins among the above resins. However, the types of resins forming the base film BF are not limited thereto. Unless otherwise specified herein, the term “polyimide” includes an imide structure and may be indicated to include “polyimide” or “polyamideimide” when in use.

In the window WM of an embodiment, the base film BF of the protective film member PM may be a polyimide film or a polyethylene terephthalate film.

In an embodiment, the base film BF may be a polyimide-based film including a unit derived from fluorine-based aromatic diamine. In an embodiment, the base film BF may be a polyimide-based film including a unit derived from a fluorine-based aromatic diamine, a unit derived from an aromatic dianhydride, and a unit derived from an aromatic diacid dichloride. Further, specifically, the polyimide-based film may further include a unit derived from a cycloaliphatic dianhydride in addition to a unit derived from a fluorine-based aromatic diamine, a unit derived from an aromatic dianhydride, and a unit derived from an aromatic diacid dichloride, for example. However, repeating units of polyimide forming the base film BF are not limited to the compound units described above.

The base film BF in an embodiment may be a polyimide film prepared through the method described above. However, the inventive concept is not limited thereto, and in an embodiment, the base film BF may be a polyethylene terephthalate film.

The base film BF may be a polymer film having excellent optical properties without a rainbow phenomenon or Mura. Accordingly, in the window WM in an embodiment, when the base film BF includes the polyimide film or the polyethylene terephthalate film described above, the window WM may exhibit excellent optical properties such as substantially low haze and substantially high transmittance.

The base film BF may have a thickness t_{BF} of about 10 micrometers (μm) to about 150 μm. In an embodiment, the base film BF may have a thickness t_{BF} of about 50 m to about 100 μm, for example. When the base film BF has a thickness t_{BF} of less than 10 μm, the window WM may have reduced durability. In addition, when the base film BF has a thickness t_{BF} of greater than 150 μm, the window WM may have a greater thickness, and may thus not be suitable for obtaining a thin display device or a foldable display device.

In an embodiment, the base film BF may be a single polymer film layer. However, the inventive concept is not limited thereto, and the base film BF may be provided in a form in which a plurality of polymer film layers are stacked.

In an embodiment, the hard coating layer HC may be disposed on the base film BF. The hard coating layer HC may be disposed above the base film BF, and the hard coating layer HC may be disposed on one surface of the base film BF closer to the first display surface FS (FIG. TA) exposed to the outside.

In an embodiment, the hard coating layer HC may be formed by providing a hard coating composition onto the base film BF through a method such as coating, and curing the hard coating composition. The hard coating layer HC may be formed by photocuring the hard coating composition. In addition, in an embodiment, the hard coating layer HC may be formed by complex curing the hard coating composition through a curing process of photocuring and thermal curing, but the inventive concept is not limited thereto. The hard coating layer HC may increase hardness and impact resistance of the window WM. In an embodiment, the hard coating layer HC may protect the base film BF from external shocks or chemical damage, for example.

The hard coating layer HC may include a siloxane-epoxy compound. That is, in an embodiment, the hard coating layer HC may include an organic-inorganic composite composition.

In an embodiment, the siloxane-epoxy compound of the hard coating layer HC may include a condensate of alkoxysilane having an epoxy group. In an embodiment, the condensate of alkoxysilane having an epoxy group may be a siloxane resin including an epoxy group, for example. However, the inventive concept is not limited thereto. A condensate of alkoxysilane having an epoxy group may have excellent hardness and flexibility properties after curing.

In an embodiment, in the condensate of alkoxysilane having an epoxy group, which provides a siloxane-epoxy compound, the epoxy group may be any one or more epoxy groups selected from aliphatic epoxy groups and aromatic epoxy groups, or functional groups including the same. In addition, in the condensate of alkoxysilane having an epoxy group, a siloxane resin may indicate a substantially high molecular compound in which silicon atoms and oxygen atoms form a covalent bond.

In an embodiment, the condensate of alkoxysilane having an epoxy group may be a silsesquioxane resin having an epoxy group. Specifically, in the condensate of alkoxysilane having an epoxy group, an epoxy group may be directly substituted on silicon atoms of a silsesquioxane resin, or an epoxy group may be substituted on a substituent substituted on silicon atoms. In an embodiment, the condensate of alkoxysilane having an epoxy group may be a silsesquioxane resin in which a 2-(3,4-epoxycyclohexyl)ethyl group is substituted, for example. However, the inventive concept is not limited thereto.

In an embodiment, the condensate of alkoxysilane having an epoxy group has a weight average molecular weight of about 1,000 grams per mole (g/mol) to about 20,000 g/mol, specifically about 1,000 g/mol to about 18,000 g/mol, more specifically about 2,000 g/mol to about 15,000 g/mol. When the weight average molecular weight is within the above-described range, the hard coating composition in an embodiment may have further improved flowability, coating properties, and curing reactivity.

In an embodiment, the condensate of alkoxysilane having an epoxy group may include a repeating unit derived from an alkoxysilane compound represented by Formula 1 below.

R¹ₙSi(OR²)₄₋₁ [Formula 1]

In Formula 1 above, R¹ may be an epoxycycloalkyl group having 3 to 7 carbon atoms or a linear or branched alkyl group having 1 to 6 carbon atoms substituted with an epoxycycloalkyl group having 3 to 7 carbon atoms or an oxiranyl group. The alkyl group may include an ether group. In Formula 1, R² is a linear or branched alkyl group having 1 to 7 carbon atoms, and n may be an integer of 1 to 3.

The alkoxysilane compound represented by Formula 1 above may be 2-(3,4-epoxycyclohexyl)ethyltrimethoxysilane, 2-(3,4-epoxycyclohexyl)ethyltriethoxysilane, 3-glycidoxypropyltrimethoxysilane, or the like. The hard coating composition may be provided alone or by mixing two or more of these alkoxysilane compounds, but the inventive concept is not limited thereto.

In addition, in an embodiment, the hard coating composition forming the hard coating layer HC may further include a crosslinking agent having a multifunctional epoxy group. In an embodiment, the crosslinking agent may include a compound having an alicyclic epoxy group. In an embodiment, the crosslinking agent may include a compound in which two 3,4-epoxycyclohexyl groups are linked, but the inventive concept is not limited thereto.

In an embodiment, the crosslinking agent may have a structure and properties similar to that of the condensate of alkoxysilane having an epoxy group, and in this case, crosslinking of the condensate of alkoxysilane having an epoxy group may be facilitated. However, the crosslinking agent may be any one or more selected from (3,4-epoxycyclohexyl)methyl-3′,4′-epoxycyclohexanecarboxylate, diglycidyl 1,2-cyclohexanedicarboxylate, 2-(3,4-epoxycyclohexyl-5,5-spiro-3,4-epoxy)cyclohexane-meta-dioxane, bis(3,4-epoxycyclohexylmethyl)adipate), bis(3,4-epoxy-6-methylcyclohexyl)adipate, 3,4-epoxy-6-methylcyclohexylmethyl-3′,4′-epoxy-6′-methylcyclohexanecarboxylate, 1,4-cyclohexanedimethanol bis(3,4-epoxycyclohexanecarboxylate), ethylenebis(3,4-epoxycyclohexanecarboxylate), 3,4-epoxycyclohexylmethyl (meth)acrylate, bis(3,4-epoxycyclohexylmethyl)adipate, 4-vinylcyclohexenedioxide, vinylcyclohexene monooxide, 1,4-cyclohexanedimethanol diglycidyl ether, and 2,2′-((1-methylethylidene)bis(cyclohexane-4,1-diyloxymethylene))bisoxirane, for example. Specifically, the crosslinking agent may be any one or more selected from (3,4-epoxycyclohexyl)methyl-3′,4′-epoxycyclohexanecarboxylate and bis(3,4-epoxycyclohexylmethyl)adipate, which include or consist of a compound to which two 3,4-epoxycyclohexyl groups are linked. The crosslinking agent may be used without being limited to the compounds described above as long as it forms crosslinking with an epoxysiloxane resin to solidify a hard coating composition and to improve hardness of a hard coating layer.

In the hard coating composition in an embodiment, the crosslinking agent may be included in an amount of 5 parts by weight to 150 parts by weight with respect to 100 parts by weight of the epoxy siloxane resin. In addition, the hard coating composition in an embodiment may include the crosslinking agent in an amount of about 3 wt % to about 30 wt % with respect to 100 wt % of a total weight of the hard coating composition. In an embodiment, the hard coating composition may include the crosslinking agent in an amount of about 5 wt % to about 20 wt % with respect to 100 wt % of a total weight of the hard coating composition, for example. When the crosslinking agent is included in an amount of about 3 wt % to about 30 wt % with respect to 100 wt % of the total weight of the hard coating composition, the hard coating composition may have improved coating properties and curing reactivity.

The hard coating composition in an embodiment may further include an initiator. The initiator may be a photoinitiator or a thermal initiator. In an embodiment, the initiator may be a photoinitiator, and in an embodiment, the hard coating composition may include a cationic photoinitiator, for example. The cationic photoinitiators may initiate polymerization of epoxysiloxane resins and epoxy-based monomers.

In an embodiment, the cationic photoinitiator may be any one or more selected from onium salts and organometallic salts, for example, but the inventive concept is not limited thereto. The cationic photoinitiator may include any one or more selected from diaryliodonium salts, triarylsulfonium salts, aryldiazonium salts, and iron-arene complexes, but the inventive concept is not limited thereto.

In an embodiment, the hard coating composition may include the photoinitiator in an amount of 1 part by weight to 15 parts by weight with respect to 100 parts by weight of the epoxysiloxane resin. In addition, in an embodiment, the hard coating composition may include the photoinitiator in an amount of about 0.1 wt % to about 10 wt %, specifically about 0.3 wt % to about 5 wt %, with respect to 100 wt % of a total weight of the hard coating composition. When the photoinitiator is included in an amount of about 0.1 wt % to about 10 wt % with respect to 100 wt % of the total weight of the hard coating composition, the hard coating composition may have excellent curing efficiency, and degradation of physical properties due to remaining components after curing in the hard coating layer HC may be minimized.

In addition, the hard coating layer HC in an embodiment may further include inorganic particles. The hard coating composition in an embodiment may further include inorganic particles to increase hardness of the hard coating layer HC.

The inorganic particles may include metal oxides such as silica, alumina, and titanium oxide; hydroxides such as aluminum hydroxide, magnesium hydroxide, and potassium hydroxide; metal particles such as gold, silver, copper, nickel, and any alloys thereof; conductive particles such as carbon, carbon nanotubes, and fullerene; glass; ceramic; or the like. The inorganic particles described above may be used alone or in a combination of two or more. In an embodiment, the hard coating composition in an embodiment may include silica, and silica may exhibit excellent compatibility with other component materials of the hard coating composition, for example.

In an embodiment, when silica is included as inorganic particles, silica may be surface-treated, for example. The surface-treated silica may include or consist of a functional group capable of reacting with the crosslinking agent described above.

In an embodiment, the inorganic particles may have an average diameter of about 1 nm to about 500 nm, e.g., about 10 nm to about 300 nm. However, the inventive concept is not limited thereto.

In an embodiment, the condensate of alkoxysilane having an epoxy group may be included in an amount of about 20 parts by weight to about 70 parts by weight with respect to 100 parts by weight of the total hard coating composition. When the condensate of alkoxysilane having an epoxy group is included in an amount of about 20 parts by weight to about 70 parts by weight, the hard coating composition may exhibit excellent flowability and excellent coating properties. In addition, uniform curing is available upon curing, so that physical defects such as cracks caused by overcuring may be more effectively prevented, and accordingly, the hard coating layer HC in an embodiment may exhibit excellent hardness.

The hard coating composition in an embodiment may further include a thermal curing agent. The thermal curing agent may include an amine-based curing agent, an imidazole-based curing agent, an acid anhydride-based curing agent, or an amide-based thermal curing agent. The hard coating composition may include the above-described thermal curing agents alone or in a combination of two or more. In an embodiment, the hard coating composition may include an acid anhydride-based thermal curing agent to prevent discoloration and to form a hard coating layer HC having substantially high hardness, for example.

In the hard coating composition in an embodiment, the thermal curing agent may be included in an amount of about 5 parts by weight to about 30 parts by weight with respect to 100 parts by weight of the condensate of alkoxysilane having an epoxy group. However, the inventive concept is not limited thereto. When the amount of the thermal curing agent is within the above range, the hard coating composition may have further improved curing efficiency to form a hard coating layer HC having excellent hardness.

The hard coating composition in an embodiment may further include a solvent. The type of solvent is not particularly limited, and solvents known in the art may be used. In an embodiment, the hard coating composition of an embodiment may include at least one of an alcohol-based (methanol, ethanol, isopropanol, butanol, methylcellusob, ethylsolusob, or the like) solvent, a ketone-based (methylethylketone, methylbutylketone, methylisobutylketone, diethyl ketone, dipropyl ketone, cyclohexanone, or the like) solvent, a hexane-based (hexane, heptane, octane, or the like) solvent, or a benzene-based (benzene, toluene, xylene, or the like) solvent, for example.

In an embodiment, the solvent may be included in a ratio of about 10 parts by weight to about 200 parts by weight with respect to 100 parts by weight of the condensate of alkoxysilane having an epoxy group. When the above range is satisfied, the hard coating composition may exhibit a proper level of viscosity, and thus workability may be greater upon forming the hard coating layer HC. In addition, a thickness of the hard coating layer HC may be easily controlled, and drying the solvent may take less time to secure faster process speed.

In an embodiment, the solvent may be included in a balance amount excluding the amount occupied by the other components of a total weight of the entirety of the hard coating composition. In an embodiment, when the total weight of the entirety of the predetermined hard coating composition is 100 grams (g) and a sum of the weights of components other than the solvent is 40 g, the solvent may be included in an amount of 60 g, but the inventive concept is not limited thereto.

In addition, the hard coating composition may further include any one or more additives selected from fillers, slip agents, photo-stabilizers, thermal polymerization prohibition agents, leveling agents, lubricants, antifoulants, thickeners, surfactants, antifoaming agents, antistatic agents, dispersants, initiators, coupling agents, antioxidants, ultraviolet (“UV”) stabilizers, colorants, or the like.

In an embodiment, the hard coating layer HC may have a thickness t_{HC} of about 1 μm to about 100 m. In an embodiment, the hard coating layer HC may have a thickness t_{HC} of about 1 μm to about 50 μm, for example, but the inventive concept is not limited thereto. When the hard coating layer HC has a thickness t_{HC} of about 1 μm to about 100 m, the hard coating layer HC may have excellent hardness and remain flexible, and may exhibit improved mechanical properties.

The hard coating layer HC in an embodiment may be formed by applying the above-described hard coating composition onto the base film BF or a layer as a substrate and curing the hard coating composition.

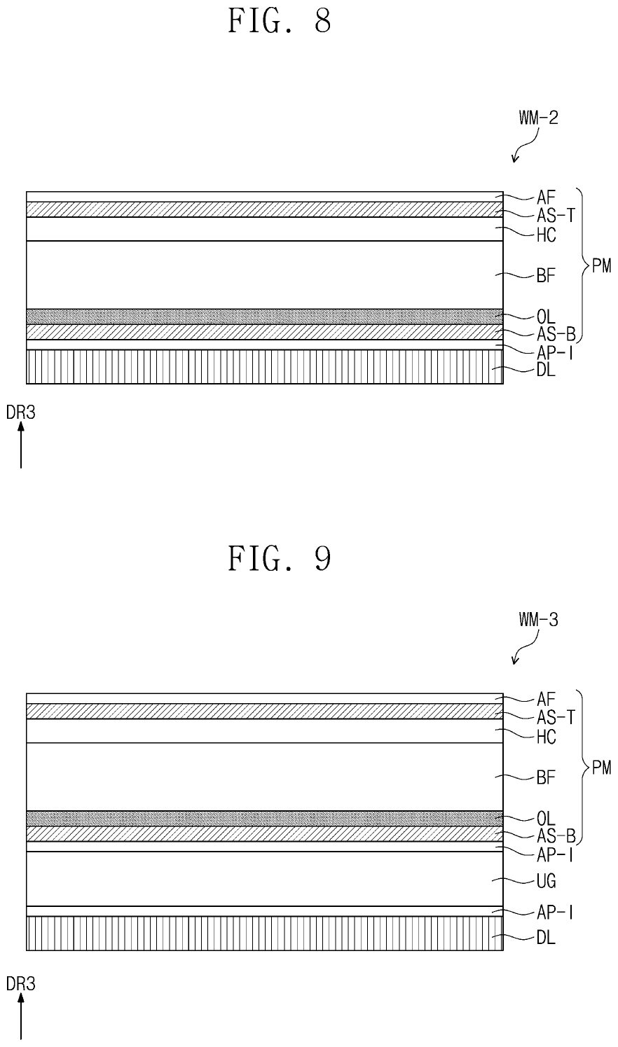

The protective film member PM in an embodiment includes antistatic layers AS-T and AS-B. The protective film member PM in an embodiment may include an upper antistatic layer AS-T disposed above the base film BF and a lower antistatic layer AS-B disposed below the base film BF. In the window WM of an embodiment shown in FIG. 8, the upper antistatic layer AS-T may be disposed above the hard coating layer HC, and the lower antistatic layer AS-B may be disposed below the optical layer OL. In an embodiment shown in FIG. 5, the upper antistatic layer AS-T may be disposed between the hard coating layer HC and the anti-fingerprint layer AF.

The antistatic layers AS-T and AS-B may be formed by applying and curing an antistatic composition including a binder and a conductive agent. In addition, the antistatic composition may further include a solvent in addition to the binder and the conductive agent.

In an embodiment, the antistatic composition may include an epoxy-based binder and a conductive agent. The epoxy-based binder may increase adhesive strength with an adjacent hard coating layer HC. In addition, the upper antistatic layer AS-T may be surface treated with plasma or the like to induce a reaction with an alkoxy silane group with respect to the anti-fingerprint layer AF, thereby improving adhesion between the anti-fingerprint layer AF and the hard coating layer HC.

The antistatic layers AS-T and AS-B include an epoxy-based binder to form a chemical bond with neighboring layers so to increase bonding strength, and accordingly, damage to layers covered by the antistatic layers AS-T and AS-B may be prevented even against oscillating abrasion or exposure to chemicals.

In addition, the anti-fingerprint layer AF has greater adhesion by surface treating the upper antistatic layer AS-T with plasma or the like before forming the anti-fingerprint layer AF, and accordingly, the anti-fingerprint layer AF may remain hydrophobic even against oscillating abrasion. Therefore, the protective film member PM of an embodiment maintains antistatic properties and hydrophobicity, and may thus exhibit further improved anti-fingerprint properties.

In addition, the upper antistatic layer AS-T is bonded between the hard coating layer HC and the anti-fingerprint layer AF through chemical bonding, and accordingly, a protective film member PM having a substantially low rate of change in surface resistance due to long-term use may be provided.

The antistatic composition used to form the antistatic layers AS-T and AS-B may include carbon nanotubes, carbon nanofibers, modified carbon nanotube surface treated with inorganic acid, or conductive polymers as a conductive agent. In an embodiment, the antistatic composition used to form the antistatic layers AS-T and AS-B in an embodiment includes single-walled or double-walled carbon nanotubes as a conductive agent, for example.

The epoxy-based binder included in the antistatic composition may include or consist of a mixed composition of an epoxy resin and an amine-based curing agent.

The epoxy resin may include at least one of a bisphenol type epoxy resin, a glycidyl ether type epoxy resin, a glycidyl ester type epoxy resin, a glycidyl amine type epoxy resin, a novolac type epoxy resin, a cresol type epoxy resin, an alkylphenol type epoxy resin, a dimer acid-modified epoxy resin, an aliphatic epoxy resin, an aliphatic cyclic epoxy resin, or an epoxidized oil-based epoxy resin. In an embodiment, the antistatic composition may include a bisphenol type epoxy resin or an alkylphenol type epoxy resin, and may specifically include a bisphenol A type epoxy resin, a bisphenol F type epoxy resin, an alkylphenol type epoxy resin, or the like, for example. The antistatic layers AS-T and AS-B formed from the antistatic composition including or consisting of a bisphenol-type epoxy resin or an alkylphenol type epoxy resin may exhibit excellent adhesiveness with neighboring layers.

Specifically, the epoxy-based binder may include epichlorohydrin-bisphenol A epoxy resins (bisphenol A diglycidyl ether type), epichlorohydrin-bisphenol AD epoxy resins, epichlorohydrin-bisphenol F epoxy resins, epoxy novolac resins; aliphatic cyclic epoxy resins obtained from 3,4-epoxyphenoxy-3′,4′-epoxyphenyl carboxy methane or the like, brominated epoxy resins in which at least one of hydrogen atoms bonded to a benzene ring in an epichlorohydrin-bisphenol A epoxy resin is substituted with a bromine atom, aliphatic epoxy resins obtained from epichlorohydrin and aliphatic dihydric alcohol, multifunctional epoxy resins obtained from epichlorohydrin and tri(hydroxyphenyl)methane, or the like.

The antistatic composition may further include an amine curing agent. The amine curing agent is not particularly limited as long as it is an amine compound other than tertiary amine (amine compound only having a tertiary amino group), but amine compounds such as aliphatic, aliphatic cyclic, aromatic, and heterocyclic amine curing agents are preferred, but the inventive concept is not limited thereto. One amine curing agent alone or two or more amine curing agents may be selected and included in the antistatic composition.

In an embodiment, aliphatic amine curing agents may be tetra(aminomethyl) methane, tetrakis(2-aminoethylamino methyl) methane, 1,3-bis(2′-aminoethylamino) propane, tris(2-aminoethyl) amine, bis(cyanoethyl) diethylenetriamine, polyoxyalkylenepolyamine (particularly diethyleneglycol bis(3-aminopropyl) ether), bis(aminomethyl)cyclohexane (1,3-BAC), isophorone diamine, menthene diamine (“MDA”), o-xylene diamine, m-xylene diamine (“MXDA”), p-xylene diamine, bis(aminomethyl)naphthalene, bis(aminoethyl) naphthalene, 1,4-bis(3-aminopropyl) piperazine, 1-(2′-aminoethylpiperazine), 1-[2′-(2″-aminoethylamino) ethyl]piperazine, or the like, for example.

The antistatic composition may include, when desired, at least one of additives such as silane coupling agents, pigments, anti-flow agents (anti-settling agents), antifoaming agents, curing accelerators such as tertiary amine, plasticizers, leveling agents, inorganic dehydrating agents, UV stabilizers, UV absorbents, antiaging agents, dispersing agents, antifouling agents, and solvents within a range not impairing the feature according to the inventive concept.

The type of solvent is not particularly limited, but may be appropriately selected and used according to coating methods or coating workability of the antistatic composition. In an embodiment, the solvent may include methyl isobutyl ketone (“MIBK”), 1-methoxy-2-propanol, methyl ethyl ketone (“MEK”), butyl acetate, n-butanol, isobutyl alcohol (“IBA”), isopropyl alcohol (“IPA”), or the like. However, the antistatic composition may not include solvents, for example.

In an embodiment, the antistatic composition includes a solvent in an amount of about 95 wt % to about 99.9 wt % with respect to 100 wt % of the total antistatic composition to easily form coating films of the antistatic layers AS-T and AS-B, in which coating film defects are suppressed. The antistatic composition may include a solvent in an amount of preferably about 95 wt % to about 99.9 wt %, more preferably about 98 wt % to about 99.9 wt % with respect to 100 wt % of the total. Specifically, the solvent may be included in an amount of about 99 wt % to about 99.9 wt % with respect to 100 wt % of the total antistatic composition.

A method of drying or curing the antistatic composition is not particularly limited, and the antistatic composition may be dried or cured by heating at a temperature of about 30° C. to about 100° C., specifically, at a temperature of about 40° C. to about 80° C. to shorten the time. The curing may take about 10 minutes, but the curing time may be regulated according to components of the antistatic composition.

The antistatic composition may include a conductive agent in an amount of about 80 wt % to about 95 wt % with respect to 100 wt % of a total weight of the antistatic layer. However, the inventive concept is not limited thereto.

When the hard coating layer HC is coated with the antistatic composition, the hard coating layer HC may be surface-modified through plasma or arc treatment, and then the antistatic composition may be provided. The surface modification may be performed in the presence of oxygen, air, or ozone gas. The surface of the hard coating layer HC may exhibit polarity by the surface modification.

In an embodiment, the upper antistatic layer AS-T and the lower antistatic layer AS-B may each independently have a thickness t_{AS} of about 1 nm to about 1000 nm. In an embodiment, the antistatic layers AS-T and AS-B may each have a thickness t_{AS} of about 10 nm to about 500 nm, or about 20 nm to about 80 nm, for example. Within the above range, antistatic properties and bonding between the hard coating layer and the anti-fingerprint layer AF may be sufficiently shown without increasing the thickness of the entirety of the protective film member PM.

The antistatic layers AS-T and AS-B are prepared by coating, drying, and curing an antistatic composition, and typical coating methods such as bar coating, flow coating, and spray coating may be used.

The antistatic layers AS-T and AS-B may have a surface resistance of about 10¹⁰ ohm per square (Ω/□) or less. In an embodiment, the surface resistance of a surface of each of the upper antistatic layer AS-T and the lower antistatic layer AS-B may be about 10¹⁰ (Ω/□) or less, for example.

In an embodiment shown in FIG. 5, the protective film member PM includes an anti-fingerprint layer AF. The anti-fingerprint layer AF may be disposed above the antistatic layer AS-T. In an embodiment, the anti-fingerprint layer AF may be directly disposed on the upper antistatic layer AS-T, but the inventive concept is not limited thereto.

In an embodiment, the anti-fingerprint layer AF may be formed from a condensation reaction of an anti-fingerprint composition including an alkoxysilane-based compound having an alkyl group in which a perfluorinated substituent and an alkylene glycol group are substituted. The alkoxysilane-based compound may be a compound represented by Formula 2 below. However, the inventive concept is not limited thereto, and any alkoxysilane compound including or consisting of an alkyl group in which a perfluorinated substituent and an alkylene glycol group are substituted is not limited thereto.

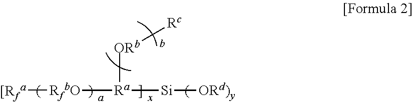

In Formula 2, R_{f}^{a} is a linear or branched perfluorinated alkyl group having 1 to 4 carbon atoms, or a linear or branched alkoxy group having 1 to 4 carbon atoms, and R_{f}^{b} is a linear or branched perfluoroalkylene group having 2 to 6 carbon atoms. In addition, in Formula 2, R^{a} is a fluorine-substituted or unsubstituted linear or branched alkylene group having 2 to 20 carbon atoms. R^{b} is a linear or branched alkylene group having 2 to 6 carbon atoms.

R^{c} is a linear or branched alkyl group having 1 to 6 carbon atoms or a linear or branched alkoxy group having 1 to 6 carbon atoms, and R^{d} is a linear or branched alkyl group having 1 to 4 carbon atoms. a and b may each be an integer of 1 to 20. In Formula 1, x is an integer of 1 to 3, and y is (4-x).

The alkoxysilane compound represented by Formula 2 may be CF₃—(OCF₂CF₂)₃—OCF₂CF₂—CH[CH₂CH₂(OCH₂CH₂)₂—OCH₃]Si(OEt)₃, CF₃—(OCF₂CF₂)₃—OCF₂CF₂CH[CH₂CH₂(OCH₂CH₂)₄—OCH₃]Si(OEt)₃, CF₃—(OCF₂CF₂)₃—OCF₂CF₂CH[CH₂CH₂(OCH₂CH₂)₆—OCH₃]Si(OEt)₃, or the like. However, the inventive concept is not limited thereto. In the embodiments of the above alkoxysilane compound, (OEt) is an ethoxy group.

The alkoxysilane-based compound represented by Formula 2 above may have excellent chemical resistance. In an embodiment, the anti-fingerprint layer AF formed from the anti-fingerprint composition including or consisting of the alkoxysilane-based compound represented by Formula 2 may be formed by being applied onto an upper surface of the upper antistatic layer AS-T and then cured. In an embodiment, an anti-fingerprint composition may be applied onto the surface of the upper antistatic layer AS-T including an epoxy-based binder and also having a hydrophilic functional group after being hydrophilic through surface treatment such as plasma, and then cured to further improve bonding strength between the anti-fingerprint layer AF and the upper antistatic layer AS-T due to chemical bonding, for example.

The alkoxysilane-based compound represented by Formula 2 may provide excellent water repellent, waterproof, and oil repellent functions to the anti-fingerprint layer AF. Accordingly, the anti-fingerprint layer AF formed by including the above-described alkoxysilane-based compound may exhibit excellent antifouling properties.

The anti-fingerprint composition may further include a solvent. In an embodiment, the solvent may include any one selected from hexafluoroxylene, hydrofluorocarbon, and hydrofluoroether, or a combination of two or more thereof, for example. Commercialized examples of the solvent may include HFE-7500, 7200, and 7100 from 3M, Vatrel XF from DuPont, and Zeolola H from Nippon Zeon, or the like, but these are only non-limiting examples, and the inventive concept is not limited thereto.

In an embodiment shown in FIG. 5, the anti-fingerprint layer AF may be formed by applying an anti-fingerprint composition onto the hydrophilic surface-modified upper antistatic layer AS-T and curing the anti-fingerprint composition. In an embodiment, the anti-fingerprint layer AF may be formed by thermally curing the applied anti-fingerprint composition, for example. Using a thermal curing method when forming the anti-fingerprint layer AF may prevent functional layers disposed below the anti-fingerprint layer AF from being re-exposed to active energy rays (e.g., UV rays) compared to a case of using a photocuring method. That is, overcuring or yellowing may be prevented as functional layers such as the cured hard coating layer HC and upper antistatic layer AS-T disposed below the anti-fingerprint layer AF are re-exposed to light.

The thermal curing of the anti-fingerprint composition may be performed at a temperature of about 50° C. to about 200° C. for 3 minutes to 30 minutes. In an embodiment, the thermal curing of the anti-fingerprint composition may be performed at a temperature of about 100° C. to about 200° C. for about 5 minutes to about 30 minutes, for example, but the inventive concept is not limited thereto. At the temperature range of about 50° C. to about 200° C., the anti-fingerprint composition may be cured at a more effective rate, and side reactions between respective components in the anti-fingerprint composition may be effectively prevented.

The anti-fingerprint layer AF in an embodiment formed from the anti-fingerprint composition including or consisting of an alkoxysilane-based compound may have an initial water contact angle of about 1100 or greater on an exposed surface. In addition, resistance to oscillating abrasion is excellent due to chemical bonding between the anti-fingerprint layer AF and the upper antistatic layer AS-T, and the water contact angle of the exposed surface of the anti-fingerprint layer AF may thus be initially about 1100 or greater, and the water contact angle may remain at about 950 or greater even after 100 scratch tests. In addition, the water contact angle may remain at about 950 or greater even after abrasion resistance and chemical resistance tests. That is, the anti-fingerprint layer AF formed from the anti-fingerprint composition including or consisting of the above-described alkoxysilane-based compound may exhibit excellent antifouling properties due to a substantially high water contact angle, and may exhibit excellent abrasion resistance and chemical resistance, or the like. A method of evaluating the water contact angle on the surface of the anti-fingerprint layer AF will be described in more detail in an evaluation method of the following embodiment.

The anti-fingerprint layer AF may have a thickness t_{AF} of about 1 nm to about 100 nm. In an embodiment, the anti-fingerprint layer AF may have a thickness t_{AF} of about 5 nm to about 50 nm, for example. When the anti-fingerprint layer has a thickness t_{AF} of about 1 nm to about 100 nm, the anti-fingerprint layer AF may exhibit excellent antifouling properties and excellent durability properties together.

The protective film member PM in an embodiment includes an optical layer OL. The optical layer OL may be disposed below the base film BF. With respect to the base film BF, the anti-fingerprint layer AF may be disposed above the base film BF, and the optical layer OL may be disposed below the base film BF. The optical layer OL may be directly disposed below the base film BF. The optical layer OL may be disposed between the base film BF and the lower antistatic layer AS-B.

The optical layer OL may be a substantially low refractive layer. The optical layer OL may be a layer having a refractive index lower than that of the base film BF. The refractive index of the optical layer OL may be relatively changed and applied according to the refractive index of the base film BF used. The refractive index of the optical layer OL may be regulated according to a combination with the refractive index of the base film BF such that the entirety of the protective film member PM has a reflectance of about 7% or less. The protective film member PM in an embodiment including the optical layer OL may have a reflectance of about 7% or less with respect to light having a wavelength of about 350 nm to about 500 nm.

The optical layer OL may reduce reflectance of the protective film member PM. The optical layer OL may have an anti-glare function. The optical layer OL has a smaller refractive index than refractive index of the base film BF, and for example, the optical layer OL may have a refractive index of about 1.0 to about 1.3. In an embodiment, the base film BF may have a refractive index of 1.67 and the optical layer OL may have a refractive index of 1.3. However, the inventive concept is not limited thereto, and the refractive index of the optical layer OL may be regulated within a range in which the protective film member PM maintains a substantially low reflectance of 7% or less.

An optical composition including any one particle selected from silica particles such as silica beads or hollow silica and acrylic particles, and an acrylic photocurable resin may be applied onto one surface of the base film BF and photocured to form the optical layer OL. In an embodiment, in an embodiment, the optical layer OL includes hollow silica particles and may thus exhibit a substantially low refractive index and excellent light transmittance, for example.

The optical composition may have a solid content of about 10 wt % or less, and for example, the optical composition may have a solid content of about 1 wt % to about 4 wt %. An amount of particles in solids of the optical composition may be about 10 wt % to about 90 wt %, and for example, an amount of particles in solids may be about 30 wt % to about 70 wt %, and the rest may be a photocurable resin component.

An average diameter of particles included in the optical layer OL may be 500 nm or less. In an embodiment, the particles may have an average diameter of about 50 nm to about 150 nm, for example. The optical layer OL having a thickness t_{of} includes particles having an average diameter of 500 nm or less to reduce reflectance, and accordingly, the protective film member PM may exhibit improved anti-glare properties.

The photocurable resin component in the optical composition may be an acrylic resin. In an embodiment, the optical composition may include, as a photocurable resin, at least one acrylic resin selected from bisphenol A type epoxy acrylate, modified type epoxy acrylate, bifunctional acrylate, and aliphatic urethane acrylate, for example. Specifically, the acrylic resin may include at least one of dicyclopentanyl diacrylate (“DCPA”), dipentaerythritol hexaacrylate (“DPHA”), difunctional acrylate, or aliphatic urethane acrylate. Commercialized photocurable acrylate-based resins include ARCS001 from Advanced Nano Products, but the inventive concept is not limited thereto.

The optical composition may further include a solvent. The solvent may include an alcohol-based (methanol, ethanol, isopropanol, butanol, methylcellusob, ethylsolsorbent, or the like) solvent, or a ketone-based (methylethylketone, methylbutylketone, methylisobutylketone, diethylketone, dipropyl ketone, cyclohexanone, or the like) solvent, and one solvent or a combination of two or more solvents may be used, for example.

The window WM of an embodiment shown in FIG. 5 may include a protective film member PM including a stack structure of functional layers such as a base film BF, antistatic layers AS-T and AS-B, a hard coating layer HC, an anti-fingerprint layer AF, and an optical layer OL formed through the materials and preparation methods described above.

The protective film member PM may include a base film BF, a hard coating layer HC disposed above the base film BF, an optical layer OL disposed below the base film BF, an upper antistatic layer AS-T disposed above the hard coating layer HC, a lower antistatic layer AS-B disposed below the optical layer OL, and an anti-fingerprint layer AF disposed above the upper antistatic layer AS-T.

In an embodiment, the placement of the upper antistatic layer AS-T and the hard coating layer HC may be changed. A window WM-a in an embodiment shown in FIG. 6 may include a protective film member PM-a including a base film BF, a hard coating layer HC disposed above the base film BF, an upper antistatic layer AS-T and an anti-fingerprint layer AF, an optical layer OL disposed below the base film BF, and a lower antistatic layer AS-B. Compared to the window WM in an embodiment shown in FIG. 5, the window WM-a shown in FIG. 6 is different in the placement of the upper antistatic layer AS-T. For each of the functional layers included in the window WM-a in an embodiment shown in FIG. 6, the above descriptions of the functional layers included in the protective film member PM of FIG. 5 may be equally applied.

Compared to the protective film member PM in an embodiment shown in FIG. 5, in an embodiment shown in FIG. 6, the upper antistatic layer AS-T may be disposed between the hard coat layer HC and the base film BF. That is, in an embodiment, the upper antistatic layer AS-T may be selectively disposed above or below the hard coating layer HC. Although not shown in the drawings, the upper antistatic layer AS-T may be disposed on an uppermost layer of the window WM-a. In this case, the hard coating layer HC may be disposed on the base film BF, the anti-fingerprint layer AF may be disposed on the hard coating layer HC, and the upper antistatic layer AS-T may be disposed on the anti-fingerprint layer AF.

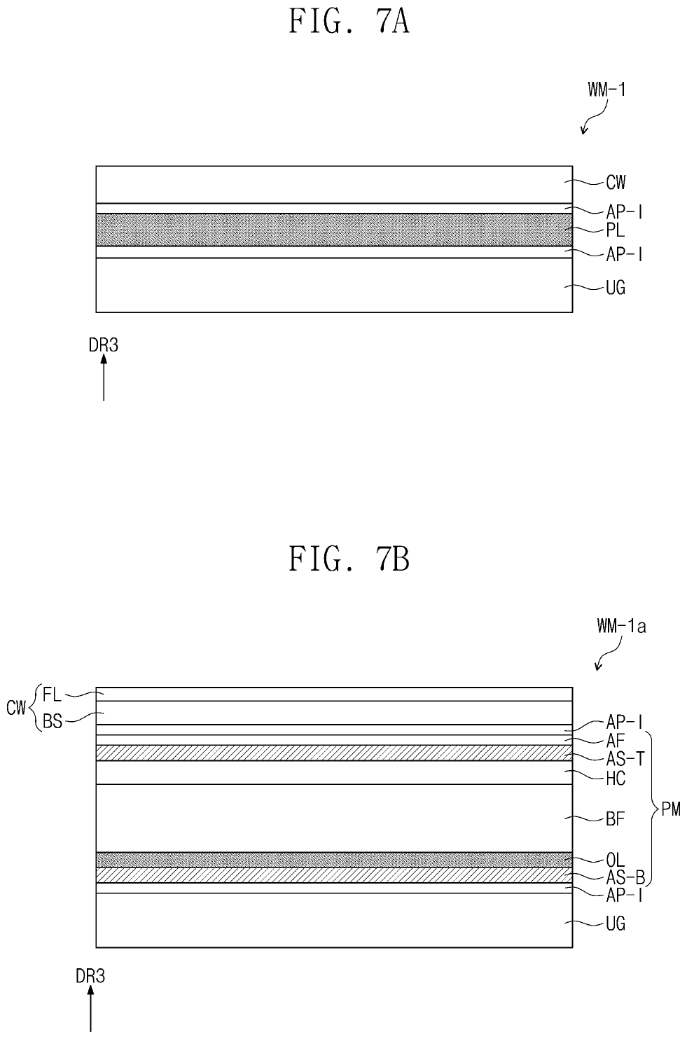

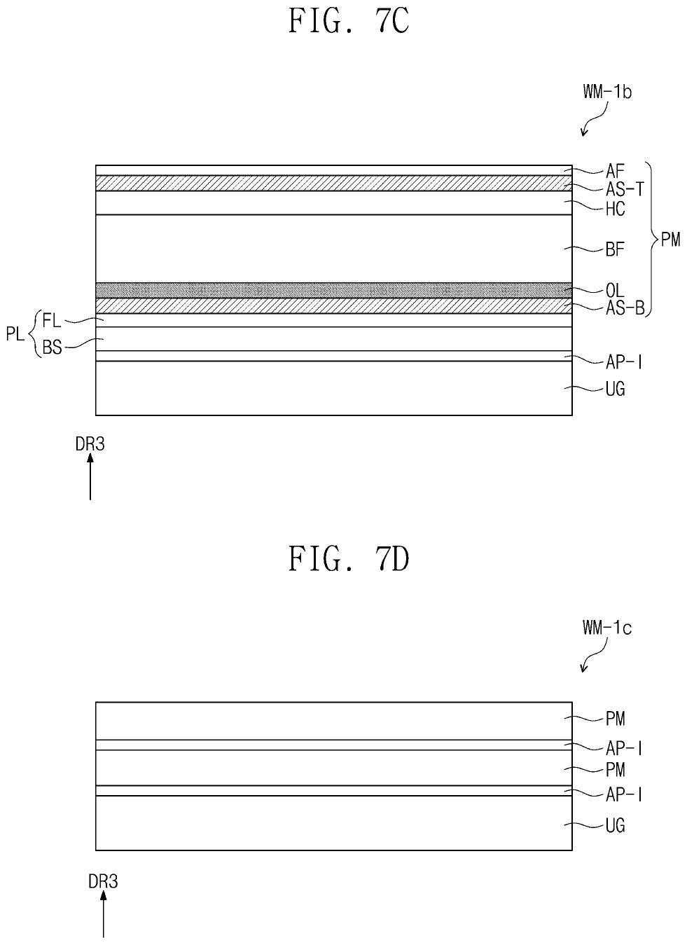

Referring to FIG. 7A, a window WM-1 in an embodiment may include a glass substrate UG, a module protective layer PL disposed on the glass substrate UG, and a cover protective layer CW disposed on the module protective layer PL.

In addition, the window WM-1 may include at least one inter-adhesive layer AP-I disposed between the glass substrate UG and the module protective layer PL or between the module protective layer PL and the cover protective layer CW. The inter-adhesive layer AP-I may be an optically transparent adhesive layer. The inter-adhesive layer AP-I may be an optically clear adhesive film (“OCA”) or an optically clear adhesive resin layer (“OCR”).

At least one of the module protective layer PL or the cover protective layer CW may be the protective film member PM or the protective film member PM-a of FIG. 5 or 6. In an embodiment, the window WM-1 may include the module protective layer PL, and the cover protective layer CW may be omitted. In addition, in an embodiment, the window WM-1 may include the module protective layer PL and the cover protective layer CW, and the glass substrate UG may be omitted.

In the window WM-1 including the cover protective layer CW, the cover protective layer CW may be an uppermost layer. The cover protective layer CW may be easily detached or replaced based on a selection of users. The module protective layer PL may be disposed below the cover protective layer CW to protect the display module DM (FIG. 4). When the cover protective layer CW is omitted, the module protective layer PL is an uppermost layer of the window WM-1 and may protect the display module DM disposed below the window from external stimulation.

The glass substrate UG may be a transparent substrate including or consisting of glass, and may be a tempered glass substrate on which at least a portion of the glass substrate UG is tempered. The glass substrate UG may be a thin glass substrate having a thickness of about 0.1 millimeter (mm) to about 1.0 mm.

FIGS. 7B and 7C are each a cross-sectional view showing an embodiment of a window. A window WM-la of an embodiment shown in FIG. 10B may include a glass substrate UG, a protective film member PM disposed on the glass substrate UG, and a cover protective layer CW disposed on the protective film member PM. In the window WM-la of an embodiment, the protective film member PM may be used as the module protective layer PL (FIG. 7A).

The protective film member PM in the window WM-la of an embodiment may have the structure of the protective film member PM in the window WM of FIG. 5 described above. However, the inventive concept is not limited thereto, and the window WM-la may include the structure of the protective film member PM-a of FIG. 6.

In addition, in the window WM-la in an embodiment, the cover protective layer CW may include a base layer BS including or consisting of a polymer material. The base layer BS may be a flexible polymer film. The base layer BS may include or consist of polyethylene terephthalate (“PET”), polyimide (“PI”), polyamide (“PA”), polyacrylate, polymethyl methacrylate (“PMMA”), polycarbonate (“PC”), or polyethylene naphthalate (“PEN”), or any combinations thereof. In an embodiment, the base film BF may be a polyethylene terephthalate film or a polyimide film. However, the base layer BS of the cover protective layer CW used in an embodiment is not limited to the presented polymer materials, and any material having optical transparency, which provides users with images provided from the display module DM (FIG. 4) and having flexibility that does not affect the folding and bending properties of the display module DM (FIG. 4) may be used without limitation.

The cover protective layer CW may include an upper functional layer FL. The upper functional layer FL may be provided as a single layer or a plurality of layers. The upper functional layer FL may serve as an anti-fingerprint layer, a hard coating layer, an antistatic layer, or an antifouling layer. In an embodiment, the upper functional layer FL may include an acrylic hard coating agent.

The window WM-1a of an embodiment may include an inter-adhesive layer AP-I disposed between the glass substrate UG and the protective film member PM and between the protective film member PM and the cover protective layer CW.

A window WM-1b of an embodiment shown in FIG. 7C may include a glass substrate UG, a module protective layer PL disposed on the glass substrate UG, and a protective film member PM disposed on the module protective layer PL. In the window WM-1b of an embodiment, the protective film member PM may be used as the cover protective layer CW (FIG. 7A).

The protective film member PM in the window WM-1b of an embodiment may have the structure of the protective film member PM in the window WM of FIG. 5 described above. However, the inventive concept is not limited thereto, and the window WM-1b may include the structure of the protective film member PM-a of FIG. 6.

In addition, in the window WM-1b of an embodiment, the module protective layer PL may include a base layer BS including or consisting of a polymer material. The base layer BS may be a flexible polymer film. The base layer BS may include or consist of polyethylene terephthalate (“PET”), polyimide (“PI”), polyamide (“PA”), polyacrylate, polymethyl methacrylate (“PMMA”), polycarbonate (“PC”), or polyethylene naphthalate (“PEN”), or any combinations thereof. In an embodiment, the base film BF may be a polyethylene terephthalate film or a polyimide film, for example. However, the base layer BS of the module protective layer PL used in an embodiment is not limited to the presented polymer materials, and any material having optical transparency, which provides users with images provided from the display module DM (FIG. 4) and having flexibility that does not affect the folding and bending characteristics of the display module DM (FIG. 4) may be used without limitation.

The module protective layer PL may include an upper functional layer FL. The upper functional layer FL may be provided as a single layer or a plurality of layers. The upper functional layer FL may serve as an anti-fingerprint layer, a hard coating layer, an antistatic layer, or an antifouling layer. In an embodiment, the upper functional layer FL may include an acrylic hard coating agent.

The window WM-1b of an embodiment may include an inter-adhesive layer AP-I disposed between the glass substrate UG and the module protective layer PL and between the module protective layer PL and the protective film member PM.

FIG. 7D is a cross-sectional view showing an embodiment of a window. A window WM-1c of an embodiment shown in FIG. 7D may include a glass substrate UG and two protective film members PM stacked and disposed on the glass substrate UG. One of the two protective film members PM may be used as the module protective layer PL (FIG. 7A) and the other one may be used as the cover protective layer CW (FIG. 7A). The protective film member PM in the window WM-1c of an embodiment may have the structure of the protective film member PM in the window WM of FIG. 5 described above. However, the inventive concept is not limited thereto, and the window WM-1c may include the structure of the protective film member PM-a of FIG. 6.

The window WM-1c of an embodiment may include an inter-adhesive layer AP-I disposed between the glass substrate UG and the protective film member PM and between the stacked protective film members PM.

FIGS. 8 and 9 are each a cross-sectional view showing an embodiment of a window. The protective film member PM in the windows WM-2 and WM-3 of an embodiment shown in FIGS. 8 and 9 may have the structure of the protective film member PM in the window WM of FIG. 5 described above. However, the inventive concept is not limited thereto, and the windows WM-2 and WM-3 of an embodiment shown in FIGS. 8 and 9 may include the structure of the protective film member PM-a of FIG. 6.

FIGS. 8 and 9 show an embodiment of a window including one protective film member PM, but the inventive concept is not limited thereto, and as described with reference to FIGS. 7A to 7D, the windows WM-2 and WM-3 of an embodiment may include two stacked protective film members PM, or may include any one of a cover protective layer CW and a module protective layer PL.

Referring to FIG. 8, a window WM-2 of an embodiment may include a protective film member PM and a shock absorbing layer DL. The shock absorbing layer DL may be disposed below the protective film member PM. The shock absorbing layer DL may be disposed below the lower antistatic layer AS-B.

Referring to FIG. 9, a window WM-3 of an embodiment may include a protective film member PM, a glass substrate UG, and a shock absorbing layer DL. In an embodiment, the shock absorbing layer DL may be disposed below the glass substrate UG.

In the windows WM-2 and WM-3 of an embodiment shown in FIGS. 8 and 9, the shock absorbing layer DL may include a polymer film. In an embodiment, the shock absorbing layer DL may include a polyethylene terephthalate film, for example. The windows WM-2 and WM-3 including the shock absorbing layer DL may have further improved impact resistance.

The window of an embodiment described with reference to FIGS. 5 to 9 includes a protective film member including a base film BF, a hard coating layer HC including or consisting of a siloxane-epoxy compound, an antistatic layers AS-T and AS-B, an anti-fingerprint layer AF, and an optical layer OL, and may thus exhibit excellent abrasion resistance and chemical resistance, excellent antifouling properties, substantially low reflectance, and substantially high transmittance properties together. In addition, the window of an embodiment includes a flexible base film BF, may thus exhibit excellent folding properties.

Hereinafter, a window in an embodiment and a display device including the same will be described in more detail through Examples and Comparative Examples. However, the following Examples and Comparative Examples are presented only as an example for describing the inventive concept in more detail, and the inventive concept is not limited to the following Examples and Comparative Examples.

### Example

1. Method of Determining Window Properties

For evaluation on physical properties of a window of an embodiment, water contact angle, abrasion resistance, chemical resistance, scratch resistance, surface resistance, or the like were evaluated. In addition, transmittance, reflectance, haze, yellowness (Y.I), modulus, elastic recovery rate, and indentation hardness were evaluated for the window. Each evaluation method is as follows.

(1) Water Contact Angle

Contact angles on surfaces were determined using a water contact angle meter (Kruss Co., DSA) in accordance with ASTM D 5946 standard. In an embodiment, in the window of an embodiment, the water contact angle was determined on a surface of an anti-fingerprint layer, for example.

(2) Abrasion Resistance

Abrasion resistance may also be also referred to as eraser abrasion resistance. The abrasion resistance was evaluated by visually observing a surface after abrasion tests with an eraser or determining the water contact angle.

The window to be evaluated was cut to a size of 7 centimeter (cm)×8 cm and fixed to a jig of an abrasion resistance measuring device (Daesung Precision Co., Ltd., scratch tester), and an eraser (Rubber stick, Minoan) having a diameter of 6 mm was applied and fixed on the TIP. A moving distance of 15 mm, a moving rate of 50 rpm, and a load of 1.0 kg were set, and the eraser was reciprocally rubbed on a surface of an anti-fingerprint layer of the test window to visually observe the surface or after 10,000 reciprocating rubbings, the water contact angle of a worn surface was determined according to the method of determining water contact angles described above.

(3) Chemical Resistance

Chemical resistance may also be also referred to as eraser chemical resistance. The chemical resistance was evaluated by visual observing the surface after applying chemicals onto the surface of the window and abrading the surface with an eraser, or by determining the water contact angle.

The window to be evaluated was cut to a size of 7 cm×8 cm and fixed to a jig of an abrasion resistance measuring device (Daejeong Precision Co., Ltd., scratch tester), and an eraser (Rubber stick, Minoan) having a diameter of 6 mm was applied and fixed on the TIP. After spraying anhydrous ethanol on a surface of an anti-fingerprint layer of the test window, in the presence of ethanol, a moving distance of 15 mm, a moving rate of 50 rpm, and a load of 1.0 kg were set, and the eraser was reciprocally rubbed on a surface of the anti-fingerprint layer of the test window to visually observe the surface or after 10,000 reciprocating rubbings, the surface was wiped several times, and the water contact angle of the worn surface was determined according to the method of determining water contact angles described above.

(4) Scratch Resistance

The window to be evaluated was cut to a size of 10 cm×12 cm and fixed to a jig of an abrasion resistance measuring device (Daesung Precision Co., Ltd.), and Steel wool (#0000, Liberon Co.) was installed and fixed on a circular Holder having a diameter of 20 mm. A moving distance of 15 mm, a moving rate of 45 rpm, and a load of 1.0 kg were set, and the Steel wool was reciprocally rubbed on a surface of an anti-fingerprint layer of the test window to visually observe the presence or absence of flaws (scratches) on the surface. After observation, it was judged as “OK” when there was no damage, and “NG” when damage took place, and the water contact angle of the worn surface was determined according to the method of determining water contact angles described above.

(5) Transmittance

Transmittance in an entirety of the visible light range was evaluated for the window to be evaluated.

(6) Reflectance

The window to be evaluated was cut to 6 cm×6 cm, and the test window was disposed (e.g., mounted) on a reflectance meter (Color Quest, Hunterlab) to determine reflectance.

(7) Haze

Haze was measured using a D65 light source with an instrument of NDH200 (NIPPON DENSHOKU).

(8) Yellowness

Yellowness was measured using a D65 light source with an instrument of CM-3600d (KONICA MINOLTA).

9) Surface Resistance

The window to be evaluated was cut to 20 cm×20 cm, and surface resistance was determined using a surface resistance meter (SRM-110, 100V).

(10) Indentation Hardness

Indentation hardness is a value measured using an indentation hardness tester. A load of 30 millinewton (mN) was applied to a sample at a loading and unloading rate of 30 s to perform measurement. Values measured for indentation hardness is Vickers Hardness (Hv) values.

(11) Modulus

Modulus was measured on the basis of a standard measurement method of ASTM D 638-03.

(12) Elastic Recovery Rate

A load cell having a predetermined weight was attached to the test window to apply load, and then changes in length and restored length after removing the load cell were determined to measure elastic recovery rate. That is, the elastic recovery rate may be reported as a ratio of the length after restoration to the changed length.

2. Method of Preparing Compositions

Hereinafter, a method of preparing compositions used to form functional layers included in a window in an embodiment is described. A number of Preparation Examples and Comparative Preparation Examples have been described for anti-fingerprint compositions in the method of preparing compositions below.

(1) Preparation of Hard Coating Composition

2-(3,4-epoxycyclohexyl)ethyltrimethoxysilane (ECTMS, TCI) and water were mixed at a ratio of 24.64 g: 2.70 g (0.1 mol: 0.15 mol) to prepare a reaction solution, which was then put into a 2-neck flask (250 milliliter (mL)). 0.1 mL of tetramethylammonium hydroxide (Aldrich) catalyst and 100 mL of tetrahydrofuran (Aldrich) were added to the combination, and the combination was stirred at 25° C. for 36 hours.

Thereafter, the resulting product was subjected to layer separation, and a product layer was extracted with methylene chloride (Aldrich Co.), moisture was removed from the extract with magnesium sulfate (Aldrich Co.), and a solvent was vacuum dried to obtain an epoxy siloxane-based resin. The epoxy siloxane-based resin had a weight average molecular weight of 2500 g/mol as measured through gel permeation chromatography (“GPC”).

30 g of the epoxy siloxane-based resin prepared as described above, 10 g of (3′,4′-epoxycyclohexyl)methyl 3,4-epoxycyclohexanecarboxylate as a crosslinking agent, 5 g of bis[(3,4-epoxycyclohexyl)methyl] adipate, 0.5 g of (4-methylphenyl)[4-(2-methylpropyl)phenyl]iodonium hexafluorophosphate as a photoinitiator, 0.1 g of 4-acetoxyphenyldimethylsulfonium hexafluoroantimonate as a thermal initiator, and 54.5 g of methyl ethyl ketone were mixed to prepare a hard coating composition.

(2) Preparation of Antistatic Composition

5 parts by weight of bisphenol A diglycidyl ether relative to single-walled carbon nanotube (0.3% solid content, Oscial's Tuball Coat E_IPA) solids, 3 parts by weight of isophorone diamine relative to resin solids, and 5 parts by weight of methyl ethyl ketone were mixed and isopropyl alcohol (“IPA”) was added to obtain a coating solution having a solid content of 0.03%.

(3) Preparation of Anti-Fingerprint Composition

### Preparation of Anti-Fingerprint Composition of Preparation Example 1

CF₃—(OCF₂CF₂)₃— OCF₂CF₂—CH[CH₂CH₂(OCH₂CH₂)₂—OCH₃]Si(OEt)₃ was diluted to have a solid content of 0.1 wt % in a fluorine-based solvent (3M Co., Novec 7500) to prepare an anti-fingerprint composition.

### Preparation of Anti-Fingerprint Composition of Preparation Example 2

An anti-fingerprint composition was prepared in the same manner as in Preparation Example 1, except that CF₃—(OCF₂CF₂)₃— OCF₂CF₂—CH[CH₂CH₂(OCH₂CH₂)₄—OCH₃]Si(OEt)₃ was used.

### Preparation of Anti-Fingerprint Composition of Preparation Example 3

An anti-fingerprint composition was prepared in the same manner as in Preparation Example 1, except that CF₃—(OCF₂CF₂)₃— OCF₂CF₂—CH[CH₂CH₂(OCH₂CH₂)₆—OCH₃]Si(OEt)₃ was used.

### Preparation of Anti-Fingerprint Composition of Comparative Preparation Example 1

An anti-fingerprint composition was prepared in the same manner as in Preparation Example 1, except that CF₃—(OCF₂CF₂)₃— OCF₂CF₂—CH[CH₂CH₂(OCH₂CH₂)₇—OCH₃]Si(OEt)₃ was used.

(4) Preparation of Optical Composition

An optical composition was prepared using ARCS 001 (2% solid content) of Advanced Nano Products (“ANP”), which includes or consists of hollow silica particles having an average diameter of 100 nm to 120 nm, a binder, and a photoinitiator. A weight ratio of the hollow silica particles and the binder in the solid content was 1:1.

3. Manufacture of Window and Evaluation of Window 1

Windows were manufactured through the method described below, and windows of Examples and Comparative Examples were evaluated through the window evaluation methods described above.

The windows of Examples 1-1 to 1-3 may be prepared through the following processes of preparing a base film, forming a hard coat layer, forming an upper antistatic layer, forming an anti-fingerprint layer, forming an optical layer, and forming a lower antistatic layer, which will be described later. The windows of Examples 1-1 to 1-3 are different in that the window of Example 1-1 includes an anti-fingerprint layer formed using the anti-fingerprint composition of Preparation Example 1, Example 1-2 includes an anti-fingerprint layer formed using the anti-fingerprint composition of Preparation Example 2, and Example 1-3 includes an anti-fingerprint layer formed using the anti-fingerprint composition of Preparation Example 3.

The window of Comparative Example 1-1 is different from Example 1-1 in that the window of Comparative Example 1-1 does not include an upper antistatic layer and a lower antistatic layer. Comparative Example 1-2 is different from Example 1-1 in that Comparative Example 1-2 does not include a lower antistatic layer. In addition, Comparative Example 1-3 is different from Example 1-1 in that Comparative Example 1-3 does not include an upper antistatic layer. Comparative Example 1-4 is different from Example 1-1 in that Comparative Example 1-4 does not include an optical layer. Comparative Example 1-5 is different from Example 1-1 in that an anti-fingerprint layer includes or consists of the anti-fingerprint composition prepared in Comparative Preparation Example 1.

(1) Preparation of Base Film

In a reactor in a nitrogen atmosphere, terephthaloyl dichloride (“TPC”) and 2,2′-bis(trifluoromethyl)-benzidine (“TFMB”) were added to a mixed solution of dichloromethane and pyridine, and the combination was stirred at 25° C. for 2 hours in a nitrogen atmosphere. In this case, a molar ratio of TPC: TFMB was 3:4 to be added, and the solid content was set to be 10 wt % to perform polymerization. Thereafter, the resulting product was precipitated in an excess of methanol, and then the solid content obtained through filtration was vacuum dried at 50° C. for 6 hours or more to obtain an oligomer, and the prepared oligomer had a formula weight (FW) of 1670 g/mol.

As a solvent, N,N-dimethylacetamide (“DMAc”), 100 moles of the oligomer, and 28.6 moles of TFMB were added into the reactor, and the combination was stirred sufficiently. Thereafter, 64.3 moles of cyclobutanetetracarboxylic dianhydride (“CBDA”) and 64.3 moles of 4,4′-hexafluoroisopropylidenediphthalic hydride (“6FDA”) were put into the reactor, and the combination was sufficiently stirred, and subjected to polymerization at 40° C. for 10 hours. In this case, the reaction solution had a solid content of 20 wt %. Then, pyridine and acetic anhydride were each sequentially added to the reaction solution in an amount of 2.5 times mol relative to the total dianhydride content, and the combination was stirred at 60° C. for 12 hours.

After the polymerization was completed, the polymerization solution was precipitated in an excess of methanol and filtered, and the obtained solid content was vacuum dried at 50° C. for 6 hours or more to obtain polyamideimide powder. The polyamideimide powder was diluted and dissolved in DMAc to 20 wt % to prepare a base film from the obtained base film composition.

The base film composition was applied onto a support (glass substrate) using an applicator, and then dried at 80° C. for 30 minutes and at 100° C. for 1 hour, and cooled at room temperature to prepare a base film. Thereafter, a base film was prepared by performing stepwise heat treatment at 100 to 200° C. for 120 minutes and at 250 to 300° C. 48 minutes (40% of the total heat treatment time) at a heating rate of 20° C./min. In this case, the base film had a thickness of 50 μm.

(2) Forming Hard Coating Layer

The hard coating composition prepared through the composition preparation method described above was applied onto one surface of the prepared base film using a Mayer bar, and then dried at 60° C. for 4 minutes. Thereafter, the resulting produce was irradiated with UV at 1/cm² using a high-pressure metal lamp, and then cured at 120° C. for 10 minutes to form a hard coating layer. In this case, the hard coating layer had a thickness of 5 μm.

(3) Forming Upper Antistatic Layer

The prepared hard coating layer was subjected to corona treatment (Enercon, CTW-0212) 4 times at 250 volts (V), and then the antistatic composition prepared through the composition preparation method was applied using Mayer bar #5, and then dried at 60° C. for 4 minutes to form an upper antistatic layer. The formed upper antistatic layer had a thickness of 30 nm.

(4) Forming Anti-Fingerprint Layer

The prepared upper antistatic layer was treated at a speed of 10 mm/sec under the condition of normal pressure plasma (APP company, Mypl-Auto 150, Ar gas 131 μm, O₂ gas 12 sccm, height 3 mm, Power 150 W), and then the anti-fingerprint composition prepared through the method of Preparation Example 1 was applied using Mayer bar #14, dried at 80° C. for 5 minutes, and then cured at 150° C. for 10 minutes to prepare an anti-fingerprint layer. The prepared anti-fingerprint layer had a thickness of 32 nm.

(5) Forming Optical Layer

The optical composition prepared through the composition preparation method was applied onto the other surface of the base film, using Mayer bar #5, and then dried at 60° C. for 4 minutes, and UV irradiated at 1 J/cm² using a high-pressure metal lamp to form an optical layer.

(6) Forming Lower Antistatic Layer

On one surface of the exposed optical layer, an antistatic composition in which single-walled carbon nanotubes (0.3% solid content, Ocsial's Tuball Coat_E IPA) was diluted with IPA at a solid content of 0.1% was applied using Mayer bar #5, and then dried at 80° C. for 3 minutes to form a lower antistatic layer.

(7) Window Evaluation Results

Table 1 shows evaluation results of the windows of Examples 1-1 to 1-3 and Comparative Examples 1-1 to 1-5 described above.

TABLE 1

| | | | | | | Compar- | Compar- | Compar- | Compar- | Compar- |
|---|---|---|---|---|---|---|---|---|---|---|
| | | | | | | ative | ative | ative | ative | ative |
| | | | Ex- | Ex- | Ex- | Ex- | Ex- | Ex- | Ex- | Ex- |
| | | | ample | ample | ample | amples | amples | amples | amples | amples |
| Item | | | 1-1 | 1-2 | 1-3 | 1-1 | 1-2 | 1-3 | 1-4 | 1-5 |
| Reflectance (%) | | | 14.8 | 4.8 | 4.8 | 4.7 | 4.7 | 4.8 | 9.5 | 4.8 |
| Surface resistance | | Upper | <10⁹ | <10⁹ | <10⁹ | over | <10⁹ | Over | Over | <10⁹ |
| (Ω/□) | | surface | | | | | | | | |
| | | Lower | <10⁹ | <10⁹ | <10⁹ | over | Over | <10⁹ | over | <10⁹ |
| | | surface | | | | | | | | |
| Water | Initial | | 113 | 113 | 112 | 114 | 113 | 113 | 113 | 111 |
| contact | After | Abrasion | 100 | 101 | 102 | 89 | 101 | 90 | 86 | 75 |
| angle | 10000 | resistance | | | | | | | | |
| (°) | wears | Chemical | 96 | 105 | 104 | 92 | 97 | 91 | 90 | 67 |
| | | resistance | | | | | | | | |
| | After | Appearance | OK | OK | OK | OK | OK | OK | OK | OK |
| | scratch | Water | 98 | 96 | 97 | 88 | 99 | 89 | 90 | 90 |
| | resistance | contact | | | | | | | | |
| | | angle | | | | | | | | |

Referring to the results of Table 1, the windows of Examples 1-1 to 1-3 had a stack structure of a protective film member in an embodiment of the inventive concept, and both upper and lower surfaces were determined to have a substantially low surface resistance of less than 10¹⁰Ω/□. Comparative Examples 1-1 to 1-3 in which an antistatic layer at least one surface was omitted were shown to have a substantially high surface resistance value of greater than 10¹⁰Ω/□. A window of an embodiment shows antistatic performance with a surface resistance value of less than 10¹⁰Ω/□, thereby minimizing static electricity generated in the window itself or in a display device manufacturing process, or contamination caused by static electricity.

In addition, the window of an embodiment includes an antistatic layer including or consisting of an antistatic composition including or consisting of an epoxy-based binder and a curing agent, and may thus exhibit excellent antistatic performance, and also exhibit substantially high bonding strength through chemical bonding with the hard coating layer and the anti-fingerprint layer.

The window of an embodiment has an initial water contact angle of 1100 or greater as measured on the anti-fingerprint layer, and may thus exhibit excellent antifouling properties. In addition, it is seen that, compared to Comparative Examples 1-1, 1-3, 1-4, 1-5, or the like, Examples remains at a water contact angle of 950 or greater after abrasion resistance and chemical resistance tests, or even after scratch resistance tests to have excellent abrasion resistance, chemical resistance, and scratch resistance.

In addition, the windows of Examples including an optical layer exhibited substantially low reflectance compared to Comparative Examples 1-4, or the like without an optical layer. That is, the window of an embodiment includes the optical layer, and may thus satisfy physical properties of the antifouling, the abrasion resistance, the chemical resistance, and the scratch resistance and also exhibit excellent optical properties with a reflectance of 7% or less.

Even compared to Example 1-1, Examples 1-2 and 1-3 further included a polyalkylene glycol unit in the anti-fingerprint composition to show excellent chemical resistance.

That is, referring to the results of Table 1, the window of an embodiment including a base film, an upper antistatic layer, a lower antistatic layer, a hard coating layer including a siloxane-epoxy compound, an anti-fingerprint layer, and an optical layer all together has excellent durability in terms of abrasion resistance, chemical resistance, and scratch resistance, and also may exhibit antistatic performance of substantially low surface resistance and substantially low reflectance and excellent optical properties as well.

1. Window Evaluation 2

Table 2 below shows evaluation results of windows of Comparative Example 2-1, Example 2-1, and Example 2-2.

In Comparative Example 2-1, a window structure in which a hard coating layer including an acrylic hard coating agent is stacked on a base film of polyethylene terephthalate is evaluated. In Comparative Example 2-1, the base film has a thickness of 65 μm, and the hard coating layer has a thickness of 5 μm.

Examples 2-1 and 2-2 may have the window structure of FIG. 8 described above. Example 2-1 and Example 2-2 are different in the type of base film. In Example 2-1, a polyimide film was used as a base film, and in Example 2-2, polyethylene terephthalate was used as a base film.

In Examples 2-1 and 2-2, the base film has a thickness of 50 μm, the hard coating layer has a thickness of 5 μm, each of the upper antistatic layer and the lower antistatic layer has a thickness of 20 nm, the optical layer has a thickness of 100 nm, and the anti-fingerprint layer has a thickness of 50 nm. The same materials used in Example 1-1 were applied to materials forming a base film, a hard coating layer, an upper antistatic layer and a lower antistatic layer, an optical layer, and an anti-fingerprint layer.

The scratch resistance, abrasion resistance, and chemical resistance in Table 2 were evaluated by visually observing surface conditions after rubbing.

TABLE 2

| | Comparative | Example | Example |
|---|---|---|---|
| Item | Examples 2-1 | 2-1 | 2-2 |
| Transmittance (%) | 91.8 | 92.3 | 92.3 |
| Haze (%) | 0.6 | 0.9 | 0.7 |
| Modulus (GPa) | 4.8 | 5.9 | 3.9 |
| Indentation hardness | 29.1 | 73.9 | 43.1 |
| (Hv) | | | |
| Scratch resistance | 0 | 500 | 500 |
| (cycle) | | | |
| Abrasion | 8k/5k | ≥10k/≥10k | ≥10k/≥10k |
| resistance/Chemical | | | |
| resistance (cycle) | | | |
| Surface resistance (Ω/□) | ≤10⁸/≥10¹² | ≤10⁸/≤10⁸ | ≤10⁸/≤10⁸ |
| (upper/lower surface) | | | |

In the evaluation of scratch resistance, scratches were observed after rubbing once in Comparative Example 2-1, and no scratches were observed in Examples 2-1 and 2-2 even after 500 times of rubbing. In addition, in the abrasion resistance and chemical resistance tests, Comparative Example 2-1 was observed that the surface was damaged after 8000 times and 5000 times of reciprocating rubbing, respectively, and Examples 2-1 and 2-2 showed satisfactory surface properties even after 10,000 times of reciprocating rubbing.

Referring to the results of Table 2, Examples 2-1 and 2-2 exhibited substantially high modulus and substantially high indentation hardness properties, and excellent scratch resistance, abrasion resistance, and chemical resistance, compared to Comparative Example 2-1. In addition, in Examples 2-1 and 2-2, opposite sides of the window showed as substantially low as 10⁸ Ω/□ or less, indicating that the two had excellent antistatic performance. In addition, Examples 2-1 and 2-2 maintained substantially high transmittance and substantially low haze values even in optical properties.

That is, it is seen that the windows of Examples exhibit excellent mechanical properties and durability, and satisfactory optical properties as well, compared to Comparative Examples.

1. Window Evaluation 3

In Table 3 below, physical properties according to changes in thickness of windows are evaluated and shown. In Table 3 below, Comparative Example 2-1 has the same structure as Comparative Example 2-1 in Table 2, Example 3-1 has the same structure as Comparative Example 2-1, and Examples 3-2 and 3-3 have the same stack structure as the stack structure of the window of Example 3-1, and are different from Example 3-1 only in the thickness of a hard coating layer and a base film.

In Example 3-2, the base film has a thickness of 80 μm, and the hard coating layer has a thickness of 5 μm, and in Example 3-3, the base film has a thickness of 80 m and the hard coating layer has a thickness of 10 μm. In Examples 3-2 and 3-3, thickness and material composition of the other stack structures are the same as in Example 2-1. In all of Examples 3-1 to 3-3, polyimide films were used as base films.

Abrasion resistance and chemical resistance in Table 3 were evaluated by visually observing surface conditions after rubbing.

TABLE 3

| | Comparative | Example | Example | Example |
|---|---|---|---|---|
| Item | Examples 2-1 | 3-1 | 3-2 | 3-3 |
| Transmittance (%) | 91.8 | 92.5 | 92.5 | 92.2 |
| Reflectance (%) | | 5.1 | 5.1 | 5.0 |
| Haze (%) | 0.6 | 0.9 | 0.8 | 0.7 |
| Yellowness | 1.1 | 1.24 | 1.29 | 1.12 |
| Modulus (GPa) | 4.8 | 5.9 | 5.6 | 5.5 |
| Elastic recovery rate | 61 | 84.6 | 85.5 | 85.8 |
| (%) | | | | |
| Indentation | 29.1 | 69.7 | 69.1 | 69.7 |
| hardness (Hv) | | | | |
| Wear | 4k/1.5k | 20k/18k | 30k/8k | 30k/7k |
| resistance/Chemical | | | | |
| resistance (cycle) | | | | |

Referring to the results of Table 3, Examples 3-1 and 3-3 exhibited substantially high modulus and substantially high indentation hardness properties, and excellent abrasion resistance/chemical resistance, compared to Comparative Example 2-1. In addition, Examples 3-1 to 3-3 showed substantially high elastic recovery rates, and accordingly, it is confirmed that the windows of Examples may exhibit satisfactory folding properties when used as a window of a foldable display device. In addition, the windows of Examples maintained substantially high transmittance and substantially low haze values even in optical properties. In the reflectance, Comparative Example 2-1 showed a reflectance of greater than 7%, and Examples 3-1 to 3-3 showed a substantially low reflectance of 7% or less.

That is, it is seen that the windows of Examples exhibit excellent mechanical properties and durability, and satisfactory optical properties as well, compared to Comparative Examples. In addition, it is seen that the windows of Examples exhibit excellent mechanical properties and durability, and satisfactory optical properties regardless of thickness changes.

1. Evaluation of Display Devices

Table 4 below shows evaluation results of impact resistance of display devices. In Table 4, Comparative Example includes a stack structure of a window including a protective film member having the structure of Comparative Example 2-1 in Table 2 and a glass substrate, and a display module, and Examples 1 to 3 each include a stack structure of a window including a protective film member having the structure of Comparative Examples 3-1 to 3-3 in Table 3 and a glass substrate. That is, thicknesses of the hard coating layers and the base films of the windows included in Comparative Example and Examples 1 to 3 are the same as described in the evaluation results of Tables 2 and 3.

In Table 4, modulus and indentation hardness are determined by evaluating values in a display device state in which display modules and windows are stacked. The impact resistance corresponds to the result of a pen drop test after disposing the display device on a granite plate.

The impact resistance was evaluated using a pen drop test. The impact resistance was evaluated by dropping a pen having a predetermined weight from a predetermined height onto an upper surface of a window, and visually observing the number of cracks in the window or the number of bright spots in a display device. In the impact resistance test, the number of bright spots and cracks in Example corresponds to an average value of the evaluation results of five test samples.

In Table 4, the total window thickness corresponds to the thickness of the entirety of the window including all components other than the hard coating layer and the base film.

TABLE 4

| | | Comparative | | | |
|---|---|---|---|---|---|
| Item | | Example | Example 1 | Example 2 | Example 3 |
| Total window | | 105 | 90 | 120 | 125 |
| thickness (μm) | | | | | |
| Modulus (GPa) | | 4.8 | 5.9 | 5.6 | 5.5 |
| Indentation | | 29.1 | 69.7 | 69.1 | 69.7 |
| hardness (Hv) | | | | | |
| Impact | Bright | 6 | 9 | 7 | 7 |
| resistance | spot | | | | |
| | Breakage | 8 | 9 | 9 | 11 |

Referring to the results of Table 4, Examples 1 to 3 show improved modulus and indentation hardness compared to Comparative Examples, and accordingly, the display devices of Examples may exhibit better mechanical properties than Comparative Examples. In addition, referring to the impact resistance results in Table 4, it is seen that Comparative Examples and Examples show similar level of impact resistance.

That is, a display device in an embodiment of the inventive concept, which includes a window including a protective film member disposed on a display module and including a base film, an upper antistatic layer, a lower antistatic layer, a hard coating layer including a siloxane-epoxy compound, an anti-fingerprint layer, and an optical layer may exhibit excellent mechanical properties.

The window of an embodiment includes a protective film member including a base film, a lower antistatic layer, an optical layer having a lower refractive index than a refractive index of the base film, an upper antistatic layer, an anti-fingerprint layer, and a hard coating layer including a siloxane-epoxy compound, and may thus exhibit excellent durability and excellent optical properties. In addition, the window of an embodiment may be used as a cover window of a foldable display device.

In addition, the display device of an embodiment includes a folding region and a non-folding region, and includes a window including a protective film member including a base film, a lower antistatic layer, an optical layer having a lower refractive index than a refractive index of the base film, an upper antistatic layer, an anti-fingerprint layer, and a hard coating layer including a siloxane-epoxy compound on a display module, and may thus exhibit excellent durability and excellent display quality.

A window of an embodiment includes a protective film member including a base film, a hard coating layer, an antistatic layer, an anti-fingerprint layer, and an optical layer, and may thus exhibit excellent abrasion resistance and chemical resistance, and excellent optical properties having reduced reflectance as well.

A display device of an embodiment includes at least one protective film member disposed above a display module and including a base film, a hard coating layer, an antistatic layer, an anti-fingerprint layer, and an optical layer, and may thus exhibit good folding properties, excellent durability, and optical properties.

Although the disclosure has been described with reference to a preferred embodiment of the inventive concept, it will be understood that the inventive concept should not be limited to these preferred embodiments but various changes and modifications may be made by those skilled in the art without departing from the spirit and scope of the disclosure.

Hence, the technical scope of the disclosure is not limited to the detailed descriptions in the specification but should be determined only with reference to the claims.

What is claimed is:

1. A window comprising:
a protective film member including:
a base film;
a lower antistatic layer disposed below the base film;
an optical layer disposed between the base film and the lower antistatic layer and having a lower refractive index than a refractive index of the base film;
an upper antistatic layer disposed above the base film;
an anti-fingerprint layer disposed above the base film; and
a hard coating layer disposed between the base film and the anti-fingerprint layer and consisting of a siloxane-epoxy-based compound.

2. The window of claim 1, wherein:
the hard coating layer is directly disposed on the base film;
the upper antistatic layer is directly disposed on the hard coating layer; and
the anti-fingerprint layer is directly disposed on the upper antistatic layer.

3. The window of claim 1, wherein:
the upper antistatic layer is directly disposed on the base film;
the hard coating layer is directly disposed on the upper antistatic layer; and
the anti-fingerprint layer is directly disposed on the hard coating layer.

4. The window of claim 1, further comprising a glass substrate disposed below the lower antistatic layer of the protective film member.

5. The window of claim 1, wherein the window comprises a glass substrate, a module protective layer disposed on the glass substrate, and a cover protective layer disposed on the module protective layer, and
at least one of the module protective layer or the cover protective layer is the protective film member.

6. The window of claim 5, wherein the module protective layer is the protective film member,
the cover protective layer comprises a base layer including a polymer film and an upper functional layer disposed on the base layer, and
the upper functional layer comprises an acrylic hard coating agent.

7. The window of claim 5, wherein the cover protective layer is the protective film member,
the module protective layer comprises a base layer including a polymer film and an upper functional layer disposed on the base layer, and
the upper functional layer comprises an acrylic hard coating agent.

8. The window of claim 1, further comprising a shock absorbing layer disposed below the protective film member,
wherein the shock absorbing layer includes a polyethylene terephthalate film.

9. The window of claim 8, further comprising a glass substrate disposed between the protective film member and the shock absorbing layer.

10. The window of claim 1, wherein the base film is a polyimide film or a polyethylene terephthalate film.

11. The window of claim 10, wherein the base film has a thickness of about micrometer to about 150 micrometers.

12. The window of claim 1, wherein the hard coating layer is formed from a hard coating composition consisting of an alkoxysilane condensate having an epoxy group.

13. The window of claim 12, wherein the hard coating composition further comprises a crosslinking agent having a multifunctional epoxy group.

14. The window of claim 12, wherein the alkoxysilane condensate having the epoxy group is a silsesquioxane resin having the epoxy group.

15. The window of claim 12, wherein the hard coating layer has a thickness of about 1 micrometer to about 100 micrometers.

16. The window of claim 1, wherein the lower antistatic layer and the upper antistatic layer include an antistatic composition including any one conductive agent selected from carbon nanotubes, carbon nanofibers, and conductive polymers, and an epoxy-based resin binder.

17. The window of claim 1, wherein the lower antistatic layer and the upper antistatic layer each has a surface resistance of less than about 10¹⁰ ohm per square.

18. The window of claim 1, wherein the anti-fingerprint layer is formed from an anti-fingerprint composition including an alkoxysilane compound consisting of a polyalkylene glycol group and a perfluorinated substituent.

19. The window of claim 1, wherein an initial water contact angle of an exposed surface of the anti-fingerprint layer is about 110° or greater.

20. The window of claim 19, wherein a water contact angle of the exposed surface of the anti-fingerprint layer is about 95° or greater after an anti-scratch test, and a water contact angle of the exposed surface of the anti-fingerprint layer is 95° or greater after abrasion resistance and chemical resistance tests.

21. The window of claim 1, wherein the anti-fingerprint layer has a thickness of about 1 nanometer to about 100 nanometers.

22. The window of claim 1, wherein the optical layer comprises hollow silica,
the hollow silica having an average diameter of about 50 nanometers to about 150 nanometers.

23. The window of claim 1, wherein the protective film member has a reflectance of 7% or less.

24. The window of claim 1, wherein the window comprises at least one folding portion folded with respect to a folding axis extending in one direction.

25. A display device comprising a folding region, and a first non-folding region and a second non-folding region spaced apart with the folding region therebetween, the display device comprising:
a display module; and
a window disposed on the display module, the window including:
a protective film member including:
a base film;
a lower antistatic layer disposed below the base film;
an optical layer disposed between the base film and the lower antistatic layer and having a lower refractive index than a refractive index of the base film;
an upper antistatic layer disposed above the base film;
an anti-fingerprint layer disposed above the base film; and
a hard coating layer disposed between the base film and the anti-fingerprint layer and consisting of a siloxane-epoxy-based compound.

26. The display device of claim 25, wherein when the first non-folding region and the second non-folding region are folded to overlap each other,
a distance between upper surfaces of the display module is smaller than a distance between the upper surfaces of the window.

27. The display device of claim 25, wherein when the first non-folding region and the second non-folding region are folded to overlap each other,
the anti-fingerprint layer is exposed to an outermost surface.

28. The display device of claim 25, wherein the window comprises a glass substrate, a module protective layer disposed on the glass substrate, and a cover protective layer disposed on the module protective layer, and
at least one of the module protective layer or the cover protective layer is the protective film member.

29. The display device of claim 25, wherein the base film is a polyimide film or a polyethylene terephthalate film.

30. The display device of claim 25, wherein the hard coating layer is formed from a hard coating composition consisting of an alkoxysilane condensate having an epoxy group.

31. The display device of claim 25, wherein the lower antistatic layer and the upper antistatic layer include an antistatic composition including any one conductive agent selected from carbon nanotubes, carbon nanofibers, and conductive polymers, and an epoxy-based resin binder.

32. The display device of claim 25, wherein the anti-fingerprint layer is formed from an anti-fingerprint composition including an alkoxysilane compound consisting of a polyalkylene glycol group and a perfluorinated substituent.

33. The display device of claim 32, wherein an initial water contact angle of an exposed surface of the anti-fingerprint layer is about 110° or greater.

34. The display device of claim 25, wherein the optical layer comprises hollow silica,
the hollow silica having an average diameter of about 50 nanometers to about 150 nanometers.

35. The display device of claim 25, wherein the window has a reflectance of about 7% or less.
